(19) United States
(12) Patent Application Publication
(10) Pub. No.: US 2022/0017425 A1
(43) Pub. Date: Jan. 20, 2022

(54) OXIDATION-INDUCED SHAPE MEMORY FIBER AND PREPARATION METHOD AND APPLICATION THEREOF

(71) Applicant: Qingdao University of Technology, Qingdao (CN)

(72) Inventors: Ziguo WANG, QINGDAO (CN); Sheng WANG, QINGDAO (CN); Yuyan SUN, QINGDAO (CN); Guibin LIU, QINGDAO (CN); Qi YU, QINGDAO (CN); Xiaomei WAN, QINGDAO (CN)

(21) Appl. No.: 17/488,369

(22) Filed: Sep. 29, 2021

Related U.S. Application Data
(63) Continuation of application No. PCT/CN2021/070938, filed on Jan. 8, 2021.

(30) Foreign Application Priority Data
Jan. 9, 2020 (CN) 202010021908.6

(51) Int. Cl. C04B 35/628; C04B 35/76

(52) U.S. Cl. CPC C04B 35/62863; C04B 35/62873; C04B 35/76; C04B 2235/74; C04B 2235/5248; C04B 2235/9684; C04B 2235/5244

(57) ABSTRACT

The present disclosure relates to an oxidation-induced shape memory fiber comprising a tension-bearing core material and/or a tension-bearing core material coated with an antioxidative coating, and an oxidizable pressure-bearing coating. The oxidizable pressure-bearing coating is coated outside the tension-bearing core material and/or the tension-bearing core material coated with an antioxidative coating; the oxidizable pressure-bearing coating is in compressive stress state and/or the tension-bearing core material coated with an antioxidative coating and the oxidizable pressure-bearing coating are in tension-compression balance state. The disclosure also relates to preparation and application thereof, the preparation is: reserving anchoring end, exerting tension force on tension-bearing core material and/or tension-bearing core material coated with an antioxidative coating, followed by coating oxidizable pressure-bearing coating thereon. The oxidation-induced shape memory fiber is applicable to high temperature oxidation environment.

### CROSS-REFERENCE TO RELATED APPLICATIONS

This application is a continuation of International Application No. PCT/CN2021/070938 with a filling date of Jan. 8, 2021, designating the United states, now pending, and further claims to the benefit of priority from Chinese Application No. 202010021908.6 with a filing date of Jan. 9, 2020. The content of the aforementioned applications, including any intervening amendments thereto, are incorporated herein by reference.

### TECHNICAL FIELD

The present disclosure relates to an oxidation-induced shape memory fiber and the preparation method and application thereof, and it belongs to the technical field of designing and preparing memory composite materials.

### BACKGROUND

Continuous C fiber toughened silicon carbide ceramic matrix composite material (C_{f}/SiC) is an essential material for the development of high-tech areas such as aerospace and it receives the most researches, being one of the most widely used and most successful ceramic matrix materials. The same problem that C_{f}/SiC and C/C composite material are faced with is that the thermal expansion mismatch between C fiber and the matrix, which causes occurrence of a lot of micro-cracks in the matrix and the formation of the oxidation channel. If it is further subjected to the exterior load, the micro-crack of the matrix will further increase and widen, the bigger the exterior load is, the wider the crack is and the stronger the oxidation reaction is, which means the shorter the service life of the composite material is.

At present, the comparatively effective antioxidation method is to seal and fill the crack by the multivariate and multilayer self-healing method (CMC-MS). However, as cracks of the matrix cannot be sealed and filled by liquid B₂O₃ in the temperature section of 370° C.˜650° C. and this temperature section is one where the C fiber can be oxidized and the most micro-cracks occur in the matrix, so the temperature scope for self-healing is 700° C.˜1200° C. Therefore, the present self-healing technique cannot entirely realize self-healing and antioxidation throughout the whole temperature section during a long time period. Nonetheless, the comparatively effective antioxidation technology, i.e. the multivariate and multilayer self-healing method is also trapped in decreasing, sealing and filling cracks caused by the thermal stress. When the material is subjected to the tension stress exerted from the outside, the crack is further widened and increased, which makes the antioxidation in the whole temperature section more difficult.

With respect to the solution to cracks and toughening of fragile materials, the prestressing technology shows excellent effects and is widely used in concrete material structures, the principle of which is to exert pressure on the concrete by using the elastic restoring force of the prestressed tendon and prevent the occurrence of cracks in the concrete so as to isolate corrosive medium with a complete protection layer and protect the rebar therein from corrosion. If the prestressing force exerted on the composite material can inhibit or prohibit the occurrence of cracks, then the antioxidation and self-healing to the composite material is an effective method. However, it is impossible for high temperature resistant composite materials that the prestressing force technology applied in the concrete is directly applied to high temperature resistant composite materials such as C_{f}/SiC and C/C, and the matrix is subjected to stress applied by tensioning countless fibers or fiber bundles. If the fiber in the composite material can act like the shape memory materials, i.e. automatically contract after excitation and exert prestressing force on the matrix to offset the cracking stress, then this will be a new path for the composite material to realize the self-healing or crack-free in the whole temperature section.

The shape memory material is an intellect material that can feel excitation from the outside and deform automatically and it can restore the molded shape to the initial state under the excitation from the outside environment (such as temperature, force and light) so as to realize the drive or the exertion of force on the outside, which means it has a very wide application prospect and has been hotspots in various research areas in recent decades. The present shape memory materials include shape memory alloy, shape memory polymer and shape memory ceramics. Due to its advantages such as high strength and big restorative force, the shape memory alloy has been widely used in many areas such as industry, aerospace and medicine; however, as its starting temperature of phase transition is low (the starting temperature of phase transition for the common titanium-nickel alloy martensite could barely break 100° C.), in addition to its problems such as low strength and high creep under high temperature, the application thereof in the high temperature above 1000° C. is restricted. The shape memory polymer and the composite material thereof (Shape Memory Polymer Composites, SMPC) show advantages such as a large restorable deformation degree, a low sensing temperature, easy to be processed and shaped and a wide application area, but due to its disadvantages such as small restorative force and low operation temperature, it cannot be used in high temperature environment. The shape memory ceramics is mainly toughened by the phase transition represented by ZrO₂ ceramics, but due to its chemical compatibility and high temperature stability, it is difficult to be applied to superhigh temperature ceramics such as carbides, borides and nitrides, resulting in a narrow application scope. Moreover, the phase transition force of the material decreases as the temperature increases. Therefore, the present shape memory material cannot exert prestressing force on the high temperature composite material to heal the crack.

In the present arts, self-healing for cracks of the composite material mainly adopts the glass viscous fluid formed after the material is oxidized to seal and fill the fissure. Reports of automatically exerting the closing force to heal the crack are rarely seen in relative literatures and reports of technologies that oxidation of materials is used to drive the automatic healing of shapes of the shape memory materials and/or repairing the fissure of the composite material are not yet seen.

### SUMMARY OF THE DISCLOSURE

As it is very difficult for the prior art to allow the composite material to heal cracks caused by outside force and temperature stress in a whole temperature section and it is hard for the present shape memory materials to be applied in the self-healing of cracks in composite materials in high temperature environment, the present disclosure provides a oxidation-induced shape memory fiber which provides a novel method for the intellectual self-healing of composite materials and a novel technical concept of exerting closing force on composite materials at any sites and any directions by allowing the oxidation mediums from the environment to enter the composite material to drive the shape restoration of the memory fiber, automatically exert closing force on the matrix, heal cracks of the matrix, improve the completeness of the composite material and prolong the service life of the composite material.

The present disclosure provides an oxidation-induced shape memory fiber; the oxidation-induced shape memory fiber comprises a tension-bearing core material and an oxidizable coating, the oxidizable pressure-bearing coating is coated outside of the tension-bearing core material and the end of the tension-bearing core material is not coated with the oxidizable pressure-bearing coating; the end of the tension-bearing core material which is not coated with the oxidizable pressure-bearing coating is defined as an anchoring end; under the equivalent oxidation conditions and experimental situations, the oxidation speed of the oxidizable pressure-bearing coating is bigger than the oxidation speed of the tension-bearing core material; the oxidizable pressure-bearing coating is in a compressive stress state along the length direction of the tension-bearing core material; and the tension-bearing core material and the oxidizable pressure-bearing coating are in a tension-compression balance state along the length direction of the tension-bearing core material; or

the oxidation-induced shape memory fiber comprises a tension-bearing core material coated with an antioxidative coating and an oxidizable pressure-bearing coating coated on the antioxidative coating and the end of the tension-bearing core material coated with the antioxidative coating is not coated with the oxidizable pressure-bearing coating; the end of the tension-bearing core material which is not coated with the oxidizable pressure-bearing coating is defined as an anchoring end; under the equivalent oxidation conditions and experimental situations, the oxidation speed of the oxidizable pressure-bearing coating is bigger than the oxidation speed of the antioxidative coating; the oxidizable pressure-bearing coating is in a compressive stress state along the length direction of the tension-bearing core material; and the oxidizable pressure-bearing coating and the tension-bearing core material coated with the antioxidative coating are in a tension-compression balance state along the length direction of the tension-bearing core material; or

the oxidation-induced shape memory fiber comprises a tension-bearing core material, an oxidizable pressure-bearing coating and an antioxidative coating; the tension-bearing core material is coated with the oxidizable pressure-bearing coating and the end of the tension-bearing core material is not coated with the oxidizable pressure-bearing coating; the end of the tension-bearing core material which is not coated with the oxidizable pressure-bearing coating is defined as an anchoring end; part of the oxidizable pressure-bearing coating is coated with the antioxidative coating; under the equivalent oxidation conditions and experimental situations, the oxidation speed of the oxidizable pressure-bearing coating is bigger than the oxidation speed of the tension-bearing core material; the oxidizable pressure-bearing coating is in a compressive stress state along the length direction of the tension-bearing core material; and the tension-bearing core material and the oxidizable pressure-bearing coating are in a tension-compression balance state along the length direction of the tension-bearing core material; or

the oxidation-induced shape memory fiber comprises a tension-bearing core material coated with an antioxidative coating and an oxidizable pressure-bearing coating coated on the antioxidative coating and the end of the tension-bearing core material coated with the antioxidative coating is not coated with the oxidizable pressure-bearing coating; the end of the tension-bearing core material which is not coated with the oxidizable pressure-bearing coating is defined as an anchoring end; part of the oxidizable pressure-bearing coating is coated with a second antioxidative coating; under the equivalent oxidation conditions and experimental situations, the oxidation speed of the oxidizable pressure-bearing coating is bigger than the oxidation speed of the antioxidative coating; the oxidizable pressure-bearing coating is in a compressive stress state along the length direction of the tension-bearing core material; the tension-bearing core material coated with an antioxidative coating and the oxidizable pressure-bearing coating are in a tension-compression balance state along the length direction of the tension-bearing core material; or

the oxidation-induced shape memory fiber comprises a tension-bearing core material, an extremely oxidizable coating and an oxidizable pressure-bearing coating; the cross-section stratification of the oxidation-induced shape memory fiber is the tension-bearing core material, the extremely oxidizable coating and the oxidizable pressure-bearing coating from inside to the outside in succession, and the end of the tension-bearing core material is not coated with the extremely oxidizable coating and the oxidizable pressure-bearing coating; the end of the tension-bearing core material which is not coated with the extremely oxidizable coating and the oxidizable pressure-bearing coating is defined as an anchoring end; under the equivalent oxidation conditions and experimental situations, the antioxidative properties of the three materials, namely tension-bearing core material, the oxidizable pressure-bearing coating and the extremely oxidizable coating, decrease successively while the cross-section oxidation loss rates increase successively; the oxidizable pressure-bearing coating is in a compressive stress state along the length direction of the tension-bearing core material; and the tension-bearing core material and the oxidizable pressure-bearing coating are in a tension-compression balance state along the length direction of the tension-bearing core material.

The present disclosure provides an oxidation-induced shape memory fiber; the oxidation environment includes at least one of gas oxidation and liquid oxidation.

The present disclosure provides an oxidation-induced shape memory fiber; the core material is chosen from at least one of the group consisting of C, SiC, B₄C and metal fiber;

the antioxidative coating is chosen from at least one of the group consisting of SiC, B₄C, ZrC, TiC, HfC, TaC, NbC, Si₃N₄, BN, AlN, TaN, CrSi₂, MoSi₂, TaSi₂, WSi₂, HfSi₂, Nb₅Si₃, V₅Si₃, CrB₂, TiB₂, ZrB₂ or the multiphase composite coating (Hf—Ta—C and Hf—Si—C) or is multilayer coating.

The oxidizable pressure-bearing coating is chosen from at least one of the group consisting of a C coating and a carbon-rich coating.

As an preferred scheme: the tension-bearing fiber of the oxidation-induced shape memory fiber is at least one of C fiber with SiC coating and SiC fiber, and the oxidizable pressure-bearing coating is at least one of C, carbon-rich Bₓ—C and carbon-rich Si_{y}—C, wherein x is or below 2, y is or below 0.5.

With respect to the structure of the tension-bearing fiber and the pressure-bearing coating, the tension-bearing fiber can be composed of a single fibril or fiber bundled by multiple fibrils and the pressure-bearing coating can be a single coating or multiple composite coating as well as multi-phases coating and functionally gradient coating etc.

The present disclosure provides an oxidation-induced shape memory fiber, the cross-section shape of which can be a circle, a polygonal, or a heteromorphic cross-section; the heteromorphic cross-section includes a groove shape, a cross shape, a tic-tac-toe shape, a trilobal shape, a quincunx shape or a star shape.

The present disclosure provides an oxidation-induced shape memory fiber, which is composed of a single fiber or a twisted line made from twisting and combining multiple fibers.

The present disclosure provides an the oxidation-induced shape memory fiber; the anchoring end plays the role of anchoring within a matrix; the anchor type of the anchoring end is chosen from the anchoring type with an exposed end. The exposed length of the anchoring type with an exposed end is l′; the l′ meets the formula:

$${l}^{′} \geq \frac{d {σ}_{f 1}}{4 \overline{τ}} .$$

The present disclosure provides a preparation method for the oxidation-induced shape memory fiber comprising: reserving the anchoring end, exerting tension force on the core material or the core material with the antioxidative coating; and then preparing a layer of oxidizable pressure-bearing coating on the surface thereon; removing the tension force to obtain the sample; or

reserving the anchoring end, exerting tension force on the core material or the core material with the antioxidative coating; then preparing a layer of oxidizable pressure-bearing coating on the surface thereof; removing the tension force, followed by coating the second antioxidative layer on the preset parts of the oxidizable pressure-bearing coating; or

reserving the anchoring end, exerting tension force on the core material or the core material with the antioxidative coating; then preparing a layer of extremely oxidizable coating on the surface thereof, followed by coating the oxidizable pressure-bearing coating outside thereof; removing the tension force to obtain the sample;

the exerted tension force is 30% to 90%, preferably 50% to 70%, of the bearing force for the tension-bearing fiber or the tension-bearing fiber with the antioxidative coating.

The present disclosure provides a second preparation method for the oxidation-induced shape memory fiber; in the whole oxidation-induced shape memory fiber, in order to allow the prestressing force exerted to the outside by the memory fiber to reach the maximum, the optimal acquisition method is as follows:

under the condition that the cross-sectional area of the oxidation-induced shape memory fiber is constant,

the magnitude of the prestressing force storage for the memory fiber is closely related to the volume fraction V_{f} of the tension-bearing fiber, and the axial force F of the tension-bearing fiber is

$$F = {σ}_{f}^{p} {A}_{f} = \frac{{E}_{c} {V}_{c} {σ}_{o} {A}_{f}}{\begin{matrix}{E}_{c} {V}_{c} + \\ {E}_{f} {V}_{f}\end{matrix}} = \frac{{E}_{c} {V}_{c} {σ}_{o} {V}_{f} A}{\begin{matrix}{E}_{c} {V}_{c} + \\ {E}_{f} {V}_{f}\end{matrix}} = \frac{( 1 - {V}_{f} ) {V}_{f}}{\begin{matrix}{E}_{c} ( 1 - {V}_{f} ) + \\ {E}_{f} {V}_{f}\end{matrix}} {E}_{c} {σ}_{o} A \qquad ( 14 )$$

when F reaches the maximum, prestressing force to the outside from memory fiber will reach the maximum;

calculating the extremum of the axial force for the tension-bearing fiber, firstly differentiating F:

$${F}^{′} = \frac{( 1 - 2 {V}_{f} ) [ \begin{matrix}{E}_{c} ( 1 - {V}_{f} ) + \\ {E}_{f} {V}_{f}\end{matrix} ] - ( {V}_{f} - {V}_{f}^{2} ) ( {E}_{f} - {E}_{c} )}{{[ {E}_{c} ( 1 - {V}_{f} ) + {E}_{f} {V}_{f} ]}^{2}} {E}_{c} {σ}_{o} A \qquad ( 15 )$$

that is

$${F}^{′} = \frac{( {E}_{c} - {E}_{f} ) {V}_{f}^{2} - 2 {E}_{c} {V}_{f} + {E}_{c}}{{[ {E}_{c} ( 1 - {V}_{f} ) + {E}_{f} {V}_{f} ]}^{2}} {E}_{c} {σ}_{o} A \qquad ( 16 )$$

assuming F′=0:

(E_{c}−E_{f})V_{f}²−2E_{c}V_{f}+E_{c}=0 (17)

when E_{c}=E_{f}, then V_{f}=½, at this time F can take an extremum, namely the Fₘₐₓ;

$${V}_{f}^{2} - \frac{2 {E}_{c}}{{E}_{c} - {E}_{f}} {V}_{f} + \frac{{E}_{c}}{{E}_{c} - {E}_{f}} = 0 ,$$

when E_{c}≠E_{f}, regarding the equation taking

$$a = \frac{{E}_{c}}{{E}_{c} - {E}_{f}} ,$$

since E_{c}>0, E_{f}>0, and then a<0 or a>1, so Δ=4a²−4a>0, the original equations have two different real roots:

$${V}_{f} = a \pm \sqrt{{a}^{2} - a} = \frac{{E}_{c} \pm \sqrt{{E}_{c} {E}_{f}}}{{E}_{c} - {E}_{f}} = \frac{1 \pm \sqrt{{E}_{f} \text{/} {E}_{c}}}{1 - {E}_{f} \text{/} {E}_{c}} \qquad ( 18 )$$

again since 0<V_{f}<1 and when E_{c}<E_{f}, then

$${V}_{f} = \frac{1 + \sqrt{{E}_{f} \text{/} {E}_{c}}}{1 - {E}_{f} \text{/} {E}_{c}} < 0 ;$$

when E_{c}>E_{f}, then

$${V}_{f} = \frac{1 + \sqrt{{E}_{f} \text{/} {E}_{c}}}{1 - {E}_{f} \text{/} {E}_{c}} > 1 ,$$

and then the real root

$${V}_{f} = \frac{1 + \sqrt{{E}_{f} \text{/} {E}_{c}}}{1 - {E}_{f} \text{/} {E}_{c}}$$

does not meet the condition of 0<V_{f}<1 and should be abandoned; and when

$${V}_{f} = a - \sqrt{{a}^{2} - a} = \frac{{E}_{c} - \sqrt{{E}_{c} {E}_{f}}}{{E}_{c} - {E}_{f}} \qquad ( 19 )$$

V_{f} meets the condition of formula 19 and can allow F to take the maximum value, namely Fₘₐₓ.

The present disclosure provides an application of an oxidation-induced shape memory fiber, wherein the oxidation-induced shape memory fiber is applied to reinforce the matrix; the matrixes include at least one of a ceramic matrix, a metal matrix and a concrete matrix and when the oxidation-induced shape memory fiber is applied into the ceramic matrix or the metal matrix, its volume usage percentage is 20-80 v %.

The present disclosure provides an application of the oxidation-induced shape memory fiber; when the material of the matrix is SiC, the core material of the oxidation-induced shape memory fiber is SiC fiber, the oxidizable pressure-bearing coating is C;

when the material of the matrix is SiC, and when the core material of the oxidation-induced shape memory fiber is C fiber with SiC coating, the oxidizable pressure-bearing coating is C;

when the oxidation-induced shape memory fiber is applied in the ultra-high temperature ceramic phase of Zr—Ti—C—B quaternary boron carbide and the core material of the oxidation-induced shape memory fiber is C fiber with SiC coating, the oxidizable pressure-bearing coating is C or carbon-rich Bₓ—C or carbon-rich Si_{y}—C, wherein x≤2, y≤0.5.

The present disclosure provides an application of the oxidation-induced shape memory fiber, wherein the oxidation-induced shape memory fiber is applied into the reinforced matrix to obtain composite materials with self-healing function; in the self-healing composite material, the memory fiber needs to be anchored in the matrix in addition to laying out the memory fiber, and the antioxidantive ability of the matrix shall be higher than that of pressure-bearing coating of the memory fiber; the pressure-bearing coating comprises a carbon-rich pressure-bearing coating.

The present disclosure provides an application of the oxidation-induced shape memory fiber; the antioxidantive abilities of each constitute of the self-healing composite material reinforced by the oxidation-induced shape memory fiber meet the following conditions: under the equivalent oxidation conditions, the tension-bearing core material and the matrix>the oxidizable pressure-bearing coating>the extremely oxidizable coating.

The present disclosure provides an application of the oxidation-induced shape memory fiber; the atomic ratio of C element in the carbon-rich pressure-bearing coating is bigger than the elemental stoichiometric ratio of the normal compounds, which can be exemplified by that the elemental stoichiometric ratio of normal boron carbide ceramics (B₄C) is 4:1 and the stoichiometric ratio of B and C element in the carbon-rich B—C pressure-bearing coating is lower than 2:1; which can also be exemplified by that the elemental stoichiometric ratio of normal silicon carbide ceramics (SiC) is 1:1 and the stoichiometric ratio of Si and C elements in the carbon-rich Si—C pressure-bearing coating is lower than 0.5:1;

the atomic ratio of C element in the carbon-rich pressure-bearing coating is bigger than the stoichiometric ratio of C element in the normal compounds and the stoichiometric ratio of M, K and C elements in carbon-rich Mₓ-K_{y}—C pressure-bearing coating meets x+y≤2, wherein M represents at least one of IVA group metal elements or absence thereof, K represents at least one elements of B, Si, N or absence thereof.

In the present disclosure, the carbon-rich pressure-bearing coating is obtained by the following solution: reserving the anchoring end, exerting tension force on the core material or the core material with an antioxidative coating; then preparing a layer of oxidizable pressure-bearing coating on the surface thereof, removing the tension force to obtain the sample; or

reserving the anchoring end, exerting tension force on the core material or the core material with the antioxidative coating; then preparing a layer of oxidizable pressure-bearing coating on the surface thereof, removing the tension force, followed by coating the second antioxidative layer on preset parts of the oxidizable pressure-bearing coating; or

reserving the anchoring end, exerting tension force on the core material or the core material with the antioxidative coating; then preparing a layer of extremely oxidizable coating on the surface thereof, followed by coating the oxidizable pressure-bearing coating outside thereof, removing the tension force to obtain the sample.

### Principles and Advantages

The basic principles for the oxidation-induced shape memory fiber and the self-healing composite material thereof:

The preparation method for the oxidation-induced shape memory fiber and its principle:

The oxidation-induced shape memory fiber (short for memory fiber in the present disclosure) is composed of the tension-bearing fiber and the pressure-bearing coating, wherein the tension-bearing fiber is composed of the antioxidative and high temperature resistant fiber material or the high temperature resistant fiber material coated with antioxidative protection coating, and it is oxidation resistant and high temperature resistant fiber; the pressure-bearing coating is composed of the coating material that can easily be oxidized by oxidation medium from the environment, namely the oxidative coating and the pressure-bearing coating is coated outside of the tension-bearing fiber; the tension-bearing fiber and the pressure-bearing coating form a tension-pressure self-balancing body. The preparation method of the memory fiber is as shown in FIG. 1 and the preparation steps are successively proceeded as (a˜e) in FIG. 1.

FIG. 1(a) shows that the tension-bearing fiber is in an unstressed state; FIG. 1(b) shows that the tension stress pretensioned on the tension-bearing fiber within the elastic scope is σₒ; FIG. 1(c) shows that under the condition that the tension stress σₒ of tension-bearing fiber is constant, and when the pressure-bearing coating is uniformly coated by methods such as surface deposition, spraying or electroplating, then the pressure-bearing coating is in an unstressed state; FIG. 1(d) shows that after the coating is finished and the tension force is removed, under the presumption that the tension-bearing fiber and the pressure-bearing coating are well combined, the slippage does not occur in neither of them during the process of removing the tension force, then the elastic restoring force of the tension-bearing fiber is exerted on the pressure-bearing coating along the axial direction of the fiber, when the tension force from the outside exerted on the tension-bearing fiber is entirely removed, then the tension-bearing fiber and the pressure-bearing coating constitute the tension-compression self-balancing body, the tension-bearing fiber stores the elastic tension strain, the pressure-bearing coating stores the elastic tension strain and the compressive stress of the pressure-bearing coating is configured as σ_{c}^{p}; FIG. 1(e) shows that by cooling from the preparation temperature, since thermal expansion coefficients of the tension-bearing fiber and the pressure-bearing coating do not match (α_{f}≠α_{c}), thermal stress occurs, the both of them build up a new force bearing balance, the stress of the pressure-bearing coating becomes σ_{c}.

The memory fiber can realize shape restoration under the environment with oxidation mediums and choices on materials for the tension-bearing fiber and the pressure-bearing coating are crucial. In the erosion environment, H₂O/O₂ is the main oxidation medium and materials of the tension-bearing fiber should be chosen as materials with strong antioxidation ability such as SiC fiber, or chosen as C fiber coated with antioxidative coating such as one coated with SiC, HfC, TaC or multiphase composite coating, multivariate multilayer coating protected C fiber. However, materials of the pressure-bearing coating should be chosen as oxidative C, carbon-rich B—C ceramics, carbon-rich SiC—C ceramics or multiphase ceramics material doped with oxidative materials.

### Shape Restoration Mechanism

The shape restoration mechanism of the memory fiber is shown in FIG. 2, under the environment with oxidation mediums, when the cross-section loss occurs in the pressure-bearing coating of the memory fiber due to oxidation, the memory fiber starts to heal and the healing process is proceeded successively in sequence of FIG. 2(a˜c). FIG. 2(a) shows the unoxidized state of the memory fiber and that the tension-bearing fiber and the pressure-bearing coating are in an original balance state. FIG. 2(b) shows that under the environment with oxidation mediums, the pressure-bearing coating firstly touches and reacts with the oxidation medium to produce oxidation products barely able to bear loads while the tension-bearing fiber has comparatively high antioxidantive ability, so changes to the cross-section and strength are small. Since the effective thickness of the force-bearing cross-section of the pressure-bearing coating becomes smaller after oxidation, under the elastic restoring force of the tension-bearing fiber, the compressive stress and contraction deformation of the remaining pressure-bearing coating continually increases and the tension-bearing fiber continually contract therewith to gradually become close to the initial length. As shown in FIG. 2(c), when the pressure-bearing coating is almost fully consumed by oxidation, the tension-bearing fiber restores to the initial length and finishes a one-way memorization effect, during which time the tension-bearing fiber is in an unstressed state.

Therefore, the oxidation-induced shape memory fiber has the two basic conditions which are necessary for possessing exerting the memory function:

(1) the pretension elastic deformation is stored along the axial direction of the tension-bearing fiber and the prepressure elastic deformation is stored in the pressure-bearing coating, both of which are in a tension-compression balance or self balance state.

(2) the pressure-bearing coating material needs to be composed of materials oxidized by oxidation mediums from the environment while the tension-bearing fiber needs to be composed of antioxidative and high temperature resistant materials, or composed of high temperature resistant materials coated with coatings with antioxidantive ability; in other words, under the same environment with oxidation medium, the antioxidantive ability of the tension-bearing fiber material is higher than the antioxidantive ability of the pressure-bearing coating material and the lose rate of the tension-bearing fiber is far below the loss rate of the pressure-bearing coating.

### The Basic Principle of the Self-Healing Composite Material

Basic conditions and principles that the memory fiber exerts the closing force are as follows:

Cracks occur in the matrix of the composite material due to factors such as the temperature and exterior forces and oxidation mediums enter the matrix along the channel of cracks to touch the memory fiber and reach the inside memory fiber. Once the environment temperature reaches a certain oxidation degree, firstly oxidation reaction and cross-section loss occur in the pressure-bearing coating of the memory fiber around the crack defects and the shape restoration of the tension-bearing fiber is excited to exert pressure on the matrix to drive the cracks to close. Under high temperature oxidation environment, the load force of the matrix material might as well be influence by oxidation and high temperature. Apart from choices that pressure-bearing coating is oxidative material and the tension-bearing fiber is antioxidative as well as the material with high temperature resistant properties, the matrix material also need to choose materials with excellent antioxidantive abilities and high temperature resistant properties to ensure the loading force of the matrix, namely under the same oxidation conditions and situations, the antioxidantive ability of both the tension-bearing fiber and the matrix need to be higher than these of the pressure-bearing coating. Besides, the oxidation loss rates of the tension-bearing fiber and the matrix need to be far below the loss rates of the pressure-bearing coating so as to ensure the restoration force of the excited memory fiber is exerted on the matrix, which prompts the closing of cracks and reach a better self-healing effect, otherwise it will be very difficult to realize the self-healing function.

Detailed principles for the self-healing is shown in FIG. 3, where the self-healing process is proceeded successively from a˜c. Figure a shows that cracks occur in the matrix, wherein sinces the oxidation mediums have not yet touched the pressure-bearing coating or the environment temperature has not yet reached the oxidative temperature, the memory fiber is in a stable state. Figure b shows that oxidation mediums (H₂O/O₂) spread to the inside of the material through cracks, the temperature has reached the oxidative degree, the pressure-bearing coating touches the oxidation mediums and is oxidized and the memory fiber is excited and retracts. Due to the restoration force on the memory fiber delivered by the anchoring function (the bonding anchoring function of the temporarily unoxidized pressure-bearing coating and the matrix) in the bonding area, thus prepressure is exerted on the matrix, and the closer to the cracks, the higher oxidation degree of pressure-bearing coating is, the bigger the cross-section loss is, the bigger the scope and size of the force closing cracks are and the smaller the crack width of the matrix is. As shown in Figure c, when the pressure-bearing coating around cracks is completely oxidized, cracks in the matrix are still not closed yet and the oxidation mediums start to touch the tension-bearing fiber. Since both the tension-bearing fiber and the matrix possess excellent antioxidantive abilities, the oxidation reaction of the pressure-bearing coating continues to spread along the axial direction of the fiber, its oxidation length continually increases and the functional scope of the restoration force continually increases. When the closing force exerted on the crack surface is big enough, the crack is compressed and closed, the channel from which the oxidation mediums enters is cut off, the oxidation is ceased and the self-healing protection function is realized. At this time, the pressure exerted on the matrix by the retraction of the tension-bearing fiber stops increasing.

However, defects such as holes may exist in the matrix material and oxidation mediums may still enter the inside of materials through holes and continues to oxidize the pressure-bearing coating in the memory fiber, which causes that the bonding and anchoring interface of the pressure-bearing coating and the matrix continually decreases and the compressed section of the matrix continually increases. When the anchoring interface is not enough to bear the tensile force produced by retraction of the memory fiber, the memory fiber will be extracted and the memory fiber cannot exert closing force on cracks effectively. Or when cracks are close to the end of the memory fiber, the surface of the pressure-bearing coating in the end area will be oxidized and the anchoring in the end will be invalid, which causes that the memory fiber unable to exert pressure on the matrix effectively and the cracks immediate to closing will be reopen. Therefore, in order to allow the memory fiber to exert compressive stress on the matrix more effectively, it's preferred to reserve a reliable anchoring end at the end of the memory fiber. As shown in FIG. 4, exposed ends without coating are reserved on both ends of the tension-bearing fiber, or end hooks are reserved on both ends to ensure the reliability of the anchoring end. The extraction of the fiber can be avoided with a reliable anchoring end either cracks are distributed in the end or all the pressure-bearing coatings are oxidized out, which allows the restoration force of the tension-bearing fiber to effectively delivered and ensures the self-healing property of the composite material.

In order to make sure that the fiber (such as C fiber) with poor antioxidantive abilities can be used as the tension-bearing fiber or to further increase the antioxidantive ability and chemical stability of the tension-bearing fiber, a single layer or multi-layers of antioxidative protection coating are coated on its surface to allow the tension-bearing fiber to possess a better chemical stability and antioxidantive ability. The principle that the memory fiber whose core fiber is coated with the antioxidative protection coating enforces the self-healing of the composite material is shown in FIG. 5. It can be discovered from the cleavage in the axis sectional view of the memory fiber that the surface of the core fiber is coated with multi-layers of coating. Apart from the antioxidative protection coating, there is one transition layer between the antioxidative protection coating and the core fiber, which can alleviate the thermal stress of the core fiber and the antioxidative protection coating. When the pressure-bearing coating is carbon-rich B—C oxidative ceramics, oxidation driving mediums are and H₂O and O₂. When the environment temperature is higher than 650° C., B element is oxidized into oxidation products of viscous state such as B₂O₃ and CO₂. When the restoration force of the tension-bearing fiber is bigger enough, cracks in the matrix will automatically close, and also due to the affects of the volume expansion of oxidants, B₂O₃ of viscous state is extruded from the fissure and the crack is entirely healed. Based on the same principle, when the pressure-bearing coating is other oxidative ceramics such as carbon-rich Si—C, the environment temperature will reach the viscous state temperature of ceramics oxidants and the oxidants will be extruded as well. Therefore, under the driving of the oxidation mediums, the restoration force of the memory fiber allows the crack to automatically close and function in combination with liquid oxidants that seal and fill cracks to reach a better effect of self-healing.

The function scope and size of the restoration force for the memory fiber are closely related to the axial oxidation length of the pressure-bearing coating. Besides, the faster the oxidation speed of the pressure-bearing coating is, the faster the closing force for cracks increases and the faster the closing speed is. In order to further increase the closing speed of cracks, as shown in FIG. 6, a comparatively thin extremely oxidizable coating such as the C coating is configured between the pressure-bearing coating and the tension-bearing fiber. As shown in FIG. 6(b) and FIG. 6(c), when the pressure-bearing coating around cracks are oxidized completely to form a funnel-shaped oxidation section, oxidation mediums will continue to enter and touch the extremely oxidizable coating and will be quickly oxidized if cracks in the matrix are still not closed. As shown in FIG. 6(d), due to the excellent antioxidantive ability of the tension-bearing fiber, the antioxidantive ability of the pressure-bearing coating is also stronger than that of the extremely oxidizable coating. Although the oxidation for the pressure-bearing coating has made some progress, it is comparatively slow, so the oxidation reaction of the extremely oxidizable coating quickly advances along the axial direction and the length of the oxidized extremely oxidizable coating that is delivered and loaded between the pressure-bearing coating and the tension-bearing fiber increases fast, for which reason the pressure-bearing coating and the tension-bearing fiber are separated fast and the pressure exerted on the pressure-bearing coating is transferred on the matrix. Therefore, the matrix can be exerted with the closing force and the closing speed of cracks can be quickened without the need to entirely oxidize the memory fiber on the pressure-bearing coating. Therefore, for the memory fiber composed of the tension-bearing fiber, the extremely oxidizable coating and the pressure-bearing coating, under the equivalent conditions and experimental situations, the antioxidantive abilities of three materials, i.e. the tension-bearing fiber, the pressure-bearing coating and the extremely oxidizable coating decrease in succession and the cross-section oxidation loss rates increase in succession.

As shown in FIG. 7, there are many forms for the memory fiber, the cleavage structures thereof from the inside to the outside are: the tension-bearing fiber/pressure-bearing coating, the core fiber/the antioxidative protection coating/the pressure-bearing coating (the tension-bearing fiber composed of the core fiber and the antioxidative protection coating), the core fiber/the transition layer/the antioxidative protection coating/the pressure-bearing coating (the tension-bearing fiber composed of the core fiber/the transition layer/the antioxidative protection coating), the tension-bearing fiber/the extremely oxidizable coating/the pressure-bearing coating. The end of the memory fiber can be configured without an anchoring end or configured with an exposed anchoring end, as shown in FIG. 8, an anchorage section of the exposed tension-bearing fiber can be added to other section of the fiber to further ensure the anchoring reliability of the memory fiber.

### Internal Force Calculation Model for the Memory Fiber and the Matrix

### Internal Force Calculation Model for the Memory Fiber

Basic Assumptions:

as the memory fiber is a monodirectional composite material with a slender proportion big enough, the following assumptions can be made in order to simplify the internal force of the memory fiber:

1) the pressure-bearing coating is uniformly coated in the tension-bearing fiber (pressure-bearing coating is an oxidative coating);

2) the interface of the tension-bearing fiber and the pressure-bearing coating is well combined and the both have excellent chemical tolerance;

3) the influence from the transversal strain of the tension-bearing fiber and the pressure-bearing coating is ignored and the poison ratio will not be considered in the formula derivation;

4) the bearing force of the tension-bearing fiber and the pressure-bearing coating are in a linear elastic state;

5) the structural unit being tension is marked as positive and being pressed is marked as negative.

Formula derivation for the internal force of the memory fiber

As shown in FIG. 9, the original length of the pressure-bearing coating to be coated on the tension-bearing fiber is set as l, the length of the anchoring end thereof is set as l′, the tension stress is set as σₒ when tensioning the tension-bearing fiber and the elongation of the original length is set as Δx₁. The length of the coating after deposition is l+Δx₁. When the tension force of the tension-bearing fiber is removed, due to the restoration force of the tension-bearing fiber, the compression deformation of the coating is set as Δx₂, both of which reach a force bearing balance and coordinated deformation, according to the Hooke's law:

the tension force of the tension-bearing fiber is:

$${F}_{f} = \frac{{E}_{f} {A}_{f}}{l} ( Δ {x}_{1} - Δ {x}_{2} ) \qquad ( 1 )$$

the pressure of the pressure-bearing coating is:

$${F}_{c} = \frac{{E}_{c} {A}_{c}}{l + Δ {x}_{1}} ( - Δ {x}_{2} ) \qquad ( 2 )$$

due to the force bearing balance, F_{f}+F_{c}=0, then

$$\frac{{E}_{f} {A}_{f}}{l} ( Δ {x}_{1} - Δ {x}_{2} ) + \frac{{E}_{c} {A}_{c}}{l + Δ {x}_{1}} ( - Δ {x}_{2} ) = 0 \qquad ( 3 )$$

namely

$$Δ {x}_{2} = \frac{{E}_{f} {A}_{f} Δ {x}_{1}}{\frac{{E}_{c} {A}_{c} l}{l + Δ {x}_{1}} + {E}_{f} {A}_{f}} \qquad ( 4 )$$

again due to:

$${σ}_{c}^{p} = {E}_{c} {ɛ}_{c} = {E}_{c} \frac{- Δ {x}_{2}}{l + Δ {x}_{1}} \qquad ( 5 )$$

by substituting formula (4) into formula (5), it is:

$${σ}_{c}^{p} = - \frac{{E}_{c} {E}_{f} {A}_{f} Δ {x}_{1}}{{E}_{c} {A}_{c} l + {E}_{f} {A}_{f} ( l + Δ {x}_{1} )} \\ taking A = {A}_{c} + {A}_{f} , as {ɛ}_{f} = \frac{Δ {x}_{1}}{l} \qquad ( 6 )$$

by dividing both the numerator and denominator in the right of formula (6) by Al, then

$${σ}_{c}^{p} = - \frac{{E}_{c} {E}_{f} {V}_{f} {ɛ}_{f}}{{E}_{c} {V}_{c} + {E}_{f} {V}_{f} ( 1 + {ɛ}_{f} )} \qquad ( 7 )$$

again by substituting

$${ɛ}_{f} = \frac{{σ}_{o}}{{E}_{f}}$$

into formula (7), the compressive stress of the pressure-bearing coating is:

$${σ}_{c}^{p} = - \frac{{E}_{c} {V}_{f} {σ}_{o}}{{E}_{c} {V}_{c} + {E}_{f} {V}_{f} + {V}_{f} {σ}_{o}} \qquad ( 8 )$$

as σₒ is far below E_{f}, so:

$${σ}_{c}^{p} \approx - \frac{{E}_{c} {V}_{f} {σ}_{o}}{{E}_{c} {V}_{c} + {E}_{f} {V}_{f}} \qquad ( 9 )$$

at this time, the expression of the prestressing force stored in the tension-bearing fiber is:

$${σ}_{f}^{p} = - \frac{{σ}_{c}^{p} {V}_{c}}{{V}_{f}} = \frac{{E}_{c} {V}_{c} {σ}_{o}}{{E}_{c} {V}_{c} + {E}_{f} {V}_{f}} \qquad ( 10 )$$

the expression for the thermal stress of the pressure-bearing coating is:

when the memory fiber is cooled by reducing temperature, as the thermal expansion coefficient of the tension-bearing fiber and the pressure-bearing coating does not match with the thermal stress, the calculation formula for the thermal stress of the coating is:

$${σ}_{c}^{T} = {E}_{c} ( {α}_{c o m} - {α}_{c} ) Δ T = \frac{( {α}_{f} - {α}_{c} ) {E}_{c} {E}_{f} {V}_{f} Δ T}{{E}_{c} {V}_{c} + {E}_{f} {V}_{f}} \qquad ( 11 )$$

wherein, the swelling coefficient of the composite material is:

$${α}_{c o m} = \frac{{α}_{c} {E}_{c} {V}_{c} + {α}_{f} {E}_{f} {V}_{f}}{{E}_{c} {V}_{c} + {E}_{f} {V}_{f}}$$

the expression for the pressure-bearing coating and the tension-bearing fiber under the resultant force of the thermal stress and the prestressing force is:

as σ_{c}^{P} and σ_{c}^{T} are overlapped, then the final stress of the pressure-bearing coating is:

$${σ}_{c} = {σ}_{c}^{T} + {σ}_{c}^{p} = \frac{( {α}_{f} - {α}_{c} ) {E}_{c} {E}_{f} {V}_{f} Δ T - {E}_{c} {V}_{f} {σ}_{o}}{{E}_{c} {V}_{c} + {E}_{f} {V}_{f}} \qquad ( 12 )$$

due to the force bearing balance of the pressure-bearing coating and the tension-bearing fiber, i.e. σ_{c}V_{c}+σ_{f}V_{f}=0, then:

the stress of the tension-bearing fiber is:

$${σ}_{f} = - \frac{{σ}_{c} {V}_{c}}{{V}_{f}} = \frac{{E}_{c} {V}_{c} {σ}_{o} - ( {α}_{f} - {α}_{c} ) {E}_{c} {E}_{f} {V}_{c} Δ T}{{E}_{c} {V}_{c} + {E}_{f} {V}_{f}} \qquad ( 13 )$$

wherein:

σₒ is the initial tension stress value of the tension-bearing fiber;

σ_{c}^{P} is the prestressing force value of the pressure-bearing coating;

σ_{c}^{T} is the thermal stress value of the pressure-bearing coating;

σ_{c} is the resultant force value of the thermal stress and the prestressing force for the pressure-bearing coating;

σ_{f} is the value of the thermal stress and the prestressing force for the tension-bearing fiber;

E_{c}, E_{f} is the elasticity modulus of the pressure-bearing coating and the tension-bearing fiber under room temperature;

V_{c}, V_{f} is respectively the volume fraction of the pressure-bearing coating and the tension-bearing fiber, V_{c}+V_{f}=1;

A_{c}, A_{f} is respectively the cross-section area of the pressure-bearing coating and the tension-bearing fiber, A_{c}+A_{f}=A;

α_{c}, α_{f} is respectively the thermal expansion coefficient of the pressure-bearing coating and the tension-bearing fiber;

ε_{c} is the stress of the balanced pressure-bearing coating; ε_{f} is the initial tension stress of the tension-bearing fiber;

ΔT=T−T_{c}, T and T_{c} are respectively the calculated temperature and non-residual thermal stress temperature point (the preparation temperature of the coating);

E₁=E_{f}V_{f}+E_{c}V_{c} is the elasticity modulus of the memory fiber.

The optimization for the memory fiber prestressing force storage

for memory fibers with the same cross-section area, the size of the memory fiber prestressing force storage is closely related to the volume fraction V_{f} of the tension-bearing fiber, the axial force stored in the tension-bearing fiber is:

$$F = {σ}_{f}^{p} {A}_{f} = \frac{{E}_{c} {V}_{c} {σ}_{o} {A}_{f}}{{E}_{c} {V}_{c} + {E}_{f} {V}_{f}} = \frac{{E}_{c} {V}_{c} {σ}_{o} {V}_{f} A}{{E}_{c} {V}_{c} + {E}_{f} {V}_{f}} = \frac{( 1 - {V}_{f} ) {V}_{f}}{{E}_{c} ( 1 - {V}_{f} ) + {E}_{f} {V}_{f}} {E}_{c} {σ}_{o} A \qquad ( 14 )$$

when F reaches the maximum, the prestressing force exerted by the memory fiber on the outside will reach the maximum.

to calculate extremum of the axial force of the tension-bearing fiber, firstly differentiating F, it is:

$${F}^{′} = \frac{( 1 - 2 {V}_{f} ) [ {E}_{c} ( 1 - {V}_{f} ) + {E}_{f} {V}_{f} ] - ( {V}_{f} - {V}_{f}^{2} ) ( {E}_{f} - {E}_{c} )}{{[ {E}_{c} ( 1 - {V}_{f} ) + {E}_{f} {V}_{f} ]}^{2}} {E}_{c} {σ}_{o} A \qquad ( 15 )$$

namely:

$${F}^{′} = \frac{( {E}_{c} - {E}_{f} ) {V}_{f}^{2} - 2 {E}_{c} {V}_{f} + {E}_{c}}{{[ {E}_{c} ( 1 - {V}_{f} ) + {E}_{f} {V}_{f} ]}^{2}} {E}_{c} {σ}_{o} A \qquad ( 16 )$$

taking F′=0, [symbol] :

(E_{c}−E_{f})V_{f}²−2E_{c}V_{f}+E_{c}=0 (17)

when E_{c}=E_{f}, then V_{f}=½, at this time F can take extremum.

when E_{c}≠E_{f}, for the equation

$${V}_{f}^{2} - \frac{2 {E}_{c}}{{E}_{c} - {E}_{f}} {V}_{f} + \frac{{E}_{c}}{{E}_{c} - {E}_{f}} = 0 ,$$

taking

$$a = \frac{{E}_{c}}{{E}_{c} - {E}_{f}} ,$$

as E_{c}>0, E_{f}>0, then a<0 or a>1, so Δ=4a²−4a>0, which means there are two different real roots for the original equation, namely:

$${V}_{f} = a \pm \sqrt{{a}^{2} - a} = \frac{{E}_{c} \pm \sqrt{{E}_{c} {E}_{f}}}{{E}_{c} - {E}_{f}} = \frac{1 \pm \sqrt{{E}_{f} / {E}_{c}}}{1 - {E}_{f} / {E}_{c}} \qquad ( 18 )$$

again as 0<V_{f}<1, and when E_{c}<E_{f}, then

$${V}_{f} = \frac{1 + \sqrt{{E}_{f} / {E}_{c}}}{1 - {E}_{f} / {E}_{c}} < 0 ;$$

when E_{c}>E_{f},

$${V}_{f} = \frac{1 + \sqrt{{E}_{f} / {E}_{c}}}{1 - {E}_{f} / {E}_{c}} > 1 ,$$

then the real root

$${V}_{f} = \frac{1 + \sqrt{{E}_{f} / {E}_{c}}}{1 - {E}_{f} / {E}_{c}}$$

does not meet the condition 0<V_{f}<1 and should be abandoned; but when

$${V}_{f} = a - \sqrt{{a}^{2} - a} = \frac{{E}_{c} - \sqrt{{E}_{c} {E}_{f}}}{{E}_{c} - {E}_{f}} \qquad ( 19 )$$

meets the condition 0<V_{f}<1, F can take maximum value.

### Internal Force Calculation for the Monodirectional Memory Fiber Enforcement

The composite material is reinforced with the above-mentioned memory fiber reserved with an anchoring end. The mechanic property of the monodirectional fiber reinforced composite material is predicted. In order to simplify the calculation, the influence from the poisson ratio on the axial stress will be ignored.

Basic Assumptions:

in order to simplify the calculation of the mutual forces of the memory fiber and the matrix, the following assumptions are made:

1) the memory fiber is monodirectionally and uniformly layout in the matrix;

2) the influence from the poisson ratio on the axial force is ignored;

3) the anchoring end and the matrix is closely combined without slippage;

4) the loading force for oxidation products of the pressure-bearing coating is ignored;

5) the tension-bearing fiber and the matrix are in a linear elastic state.

The stress σₘ₁ of the matrix is composed and overlapped by two part, one part of which is the precompressive stress σₘ₁^{p} exerted on the matrix by the retraction of the tension-bearing fiber; the other part of which is the thermal stress σₘ₁^{T} produced by the mismatch of the tension-bearing fiber and the thermal expansion coefficient of the matrix.

Stress Changes to the Matrix

When the preparation temperature T_{c} of the memory fiber is not consistent with the preparation temperature T_{com} of the composite material and if the tension-bearing fiber mismatches with the swelling of the matrix, during the preparation of the composite material, due to changes occurred in the thermal stress, the stress of the tension-bearing fiber at the T_{com} temperature can be calculated according to formula (13):

$${σ}_{f o} = \frac{{E}_{c} {V}_{c} {σ}_{o} - ( {α}_{f} - {α}_{c} ) {E}_{c} {E}_{f} {V}_{c} Δ {T}_{1}}{{E}_{1}} \qquad ( 20 )$$

When the whole cross-section of pressure-bearing coating is loss from oxidation, the oxidation products are not involved in bearing forces, the shape restoration of the memory fiber will be completely finished. As the oxidized pressure-bearing coating is not involved in working, the force bearing balance body is finally composed of the tension-bearing fiber and the matrix. If the preparation temperature T_{com} of the composite material is set as the thermal stress initial temperature of the tension-bearing fiber and the matrix, then σ_{fo} is equivalent to the initial tension stress. According to formula (9), the prestressing force σₘ₁^{p} exerted on the matrix by the retraction of the tension-bearing fiber:

$${σ}_{m 1}^{p} = - \frac{{E}_{m} \frac{{V}_{f 1}}{1 - {V}_{c 1}} {σ}_{fo}}{{E}_{2}} = - \frac{{E}_{m} {V}_{f 1} {σ}_{fo}}{{E}_{f} {V}_{f 1} + {E}_{m} {V}_{m}} \qquad ( 21 )$$

When the composite material is subjected to temperature reduction or temperature rise from the preparation temperature T_{com}, according to formula (10), the resulted thermal stress σₘ₁^{T} of the matrix is:

$${σ}_{m 1}^{T} = \frac{( {α}_{f} - {α}_{m} ) {E}_{m} {E}_{f} \frac{{V}_{f 1}}{1 - {V}_{c 1}} Δ {T}_{2}}{{E}_{2}} = \frac{( {α}_{f} - {α}_{m} ) {E}_{m} {E}_{f} {V}_{f 1} Δ {T}_{2}}{{E}_{f} {V}_{f 1} + {E}_{m} {y}_{m}} \qquad ( 22 )$$

Therefore, the stress of the matrix obtained by overlapping the thermal stress and the prestressing force is:

$${σ}_{m 1} = {σ}_{m 1}^{T} + {σ}_{m 1}^{p} = \frac{( {α}_{f} - {α}_{m} ) {E}_{m} {E}_{f} {V}_{f 1} Δ {T}_{2} - {E}_{m} {V}_{f 1} {σ}_{f o}}{{E}_{f} {V}_{f 1} + {E}_{m} {V}_{m}} \qquad ( 23 )$$

at this time, the stress of the tension-bearing fiber is:

$${σ}_{f 1} = \frac{{σ}_{m 1} {V}_{m}}{{V}_{f 1}} \qquad ( 24 )$$

wherein, the elasticity modulus of the memory fiber is: E₁=E_{f}V_{f}+E_{c}V_{c};

the composite elasticity modulus of the tension-bearing fiber and the matrix is:

$${E}_{2} = {E}_{f} \frac{{V}_{f 1}}{1 - {V}_{c 1}} + {E}_{m} \frac{{V}_{m}}{1 - {V}_{c 1}} ;$$

the thermal expansion coefficient of the matrix: αₘ;

the elasticity modulus of the matrix: Eₘ;

the volume fractions of the tension-bearing fiber, the pressure-bearing coating and the matrix are respectively: V_{f}, V_{c1}, Vₘ, V_{f1}=V_{c1}=Vₛ, V_{f1}+V_{c1}+Vₘ=1;

ΔT₁=T_{com}−T_{c};

ΔT₂=T−T_{com}.

the limiting value of the exposed length for the end of the tension-bearing fiber:

As shown in FIG. 4 and FIG. 9, both ends of the tension-bearing fiber are reserved with an exposed end with the length l′ and without the pressure-bearing coating. In order to ensure the reliability of the anchoring end, there is a smallest value for the length of the exposed end to allow that the pressure-bearing coating of the memory fiber will not be extracted even if being completely oxidized out.

the anchoring force of the exposed end and the matrix is:

Fₐ=πdl′τ̅ (25)

the tensile force of the memory fiber is:

F_{d}=¼πd²σ_{f1} (26)

In order to allow the exposed end of the tension-bearing fiber not to be extracted and the restoration force of the tension-bearing fiber is effectively delivered to ensure the self-healing property of the composite material, then Fₐ≥F_{d}, namely

$${l}^{′} \geq \frac{d {σ}_{f 1}}{4 \overline{τ}} \qquad ( 27 )$$

wherein, d is the diameter of the tension-bearing fiber, τ̅ is the average bonding strength of the exposed end of the tension-bearing fiber and the matrix, σ_{f1} is the stress of the tension-bearing fiber.

Compared with the prior arts, the present disclosure has the following advantages:

1, by coating the pressure-bearing coating on the surface of the pretensioned tension-bearing fiber, a memory fiber (the tension-bearing fiber is composed of the antioxidative material or materials coated with the antioxidative coating and the pressure-bearing coating is composed of materials readily oxidized by oxidation mediums from the environment) can be obtained, and it can perform shape memory restoration under the excitement of oxidation mediums.

2, oxidation mediums entered from defects such as cracks oxidize the pressure-bearing coating, the memory fiber in the composite material undergoes shape memory restoration under excitements and exerts prepressure on the matrix to provide power for the crack healing of the matrix.

3, the magnitude of the prestressing force exerted on the matrix is proportional to the sizes of both the volume fraction and the initial tension stress of the memory fiber. Beside, the severer the oxidation of the pressure-bearing coating is, the bigger the exerted prestressing force is. When the prestressing force is big enough, the crack will finally be healed.

4, cracks in the matrix are healed under the function of prepressure, which allows the mechanic property, antioxidantive ability and safety of the composite material to improve.

The present disclosure provides a brand new designing thought for the shape memory materials and provides a brand new concept for the self-repairing and self-healing in the whole temperature section of high temperature composite materials such as carbon/carbon, the metal matrix and the ceramics matrix.

### BRIEF DESCRIPTION OF DRAWINGS

FIG. 1 is the preparation principle of the shape memory fiber;

FIG. 2 is the shape restoration mechanism of the oxidation-induced shape memory fiber;

FIG. 3 is the self-healing principle map for the oxidation driven memory fiber;

FIG. 4 is the self-healing principle map for the memory fiber with an eternal anchoring end;

FIG. 5 is the self-healing principle map of the tension-bearing fiber coated with the antioxidative protection coating;

FIG. 6 is the self-healing principle map of the tension-bearing fiber coated with the extremely oxidizable coating;

FIG. 7 is the schematic map for the type of the memory fiber;

FIG. 8 is the stereo schematic map of the anchoring end;

FIG. 9 is the mechanic model of the memory fiber;

FIG. 10 shows that changes to the dosage and the initial tensile stress of the memory fiber influence the prestressing force of the matrix;

FIG. 11 is the schematic map of the simple device for the continual preparation memory fiber;

FIG. 12 is the schematic map of the finite element model;

FIG. 13 is the schematic map of the unit grid division;

FIG. 14 is the schematic map of comparison result for the simulated oxidation.

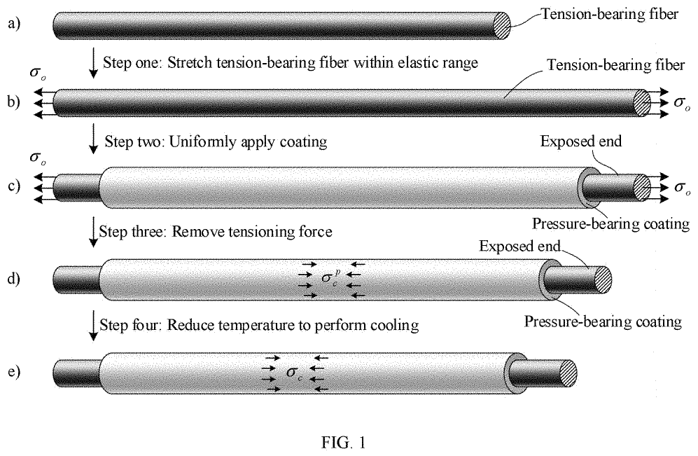

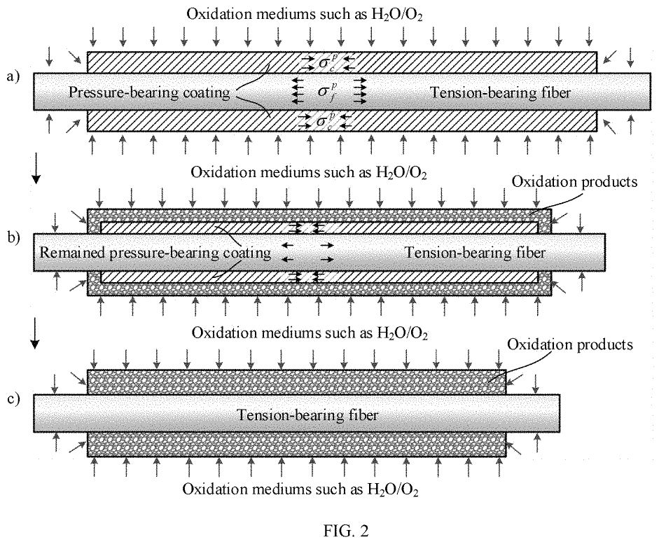

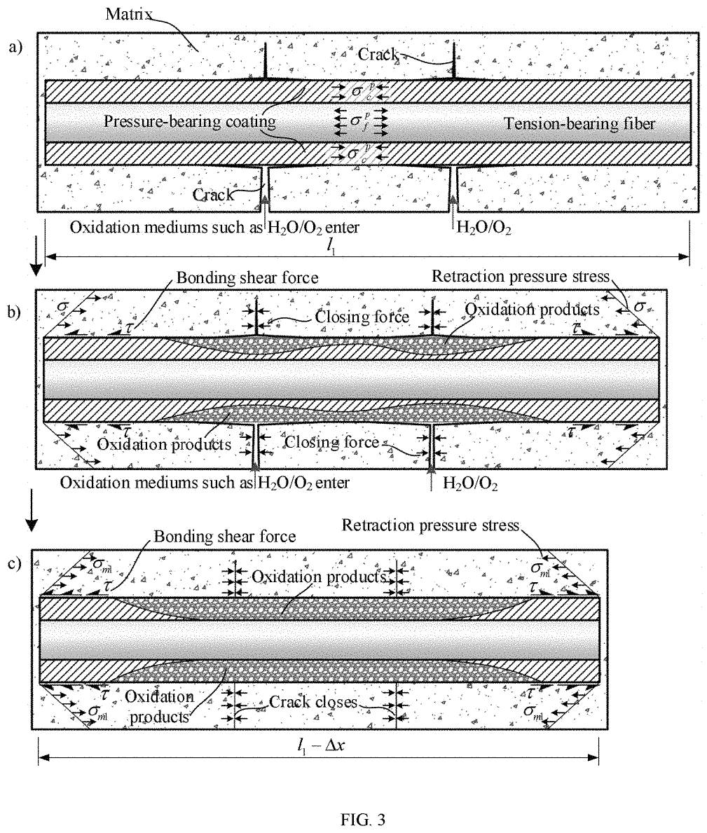

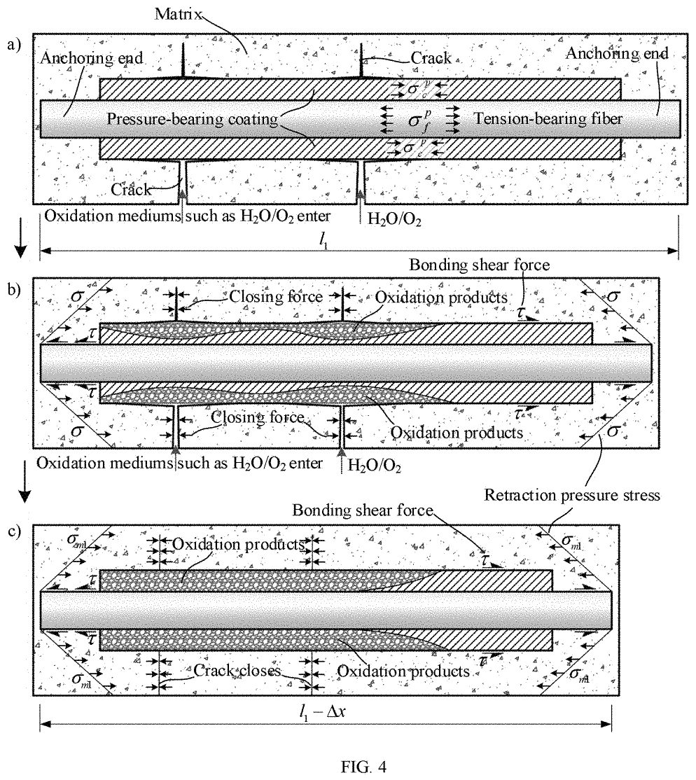

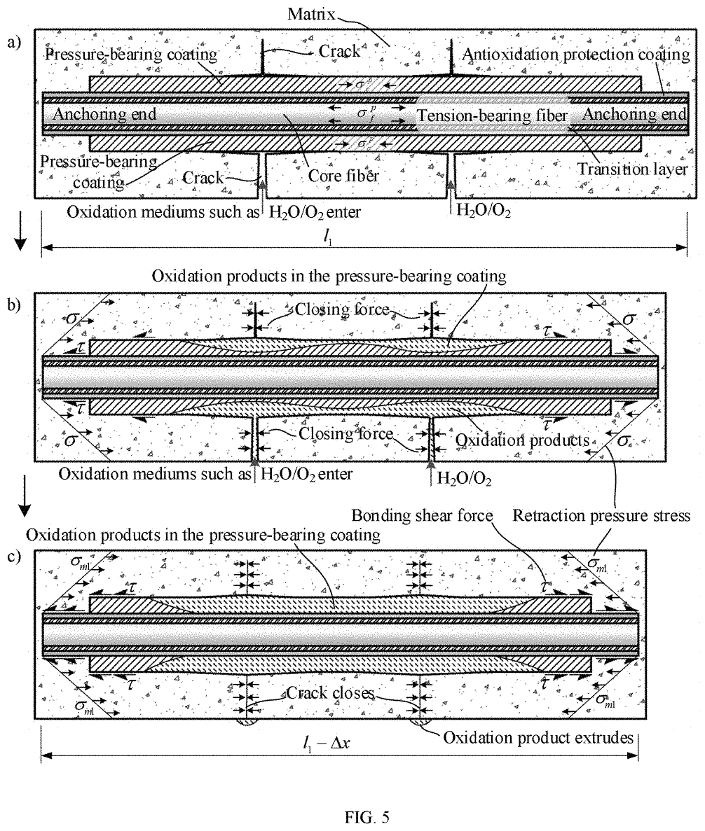

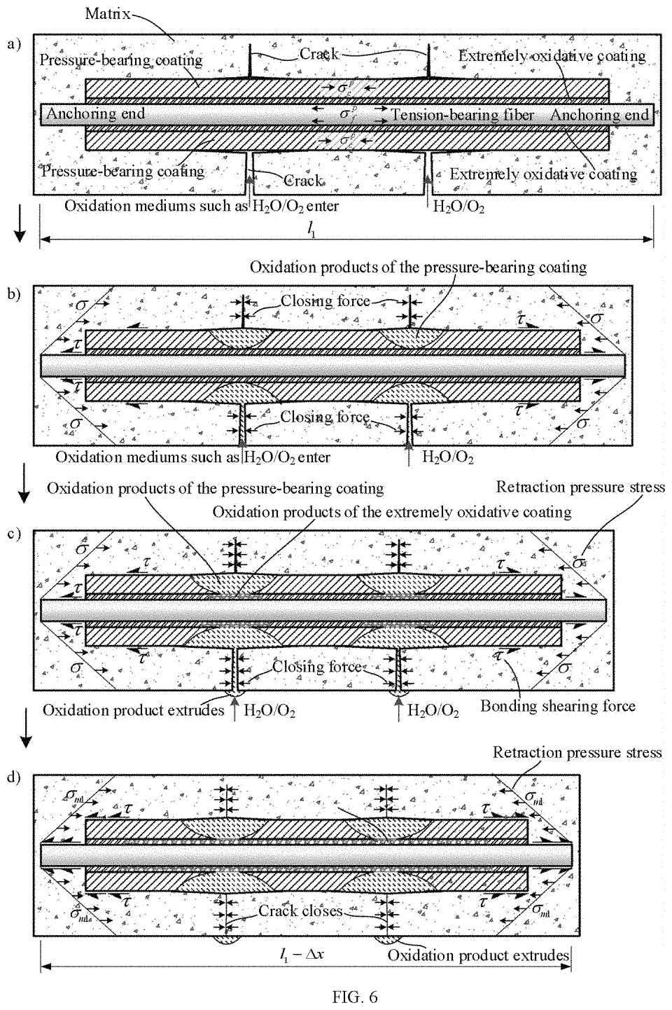

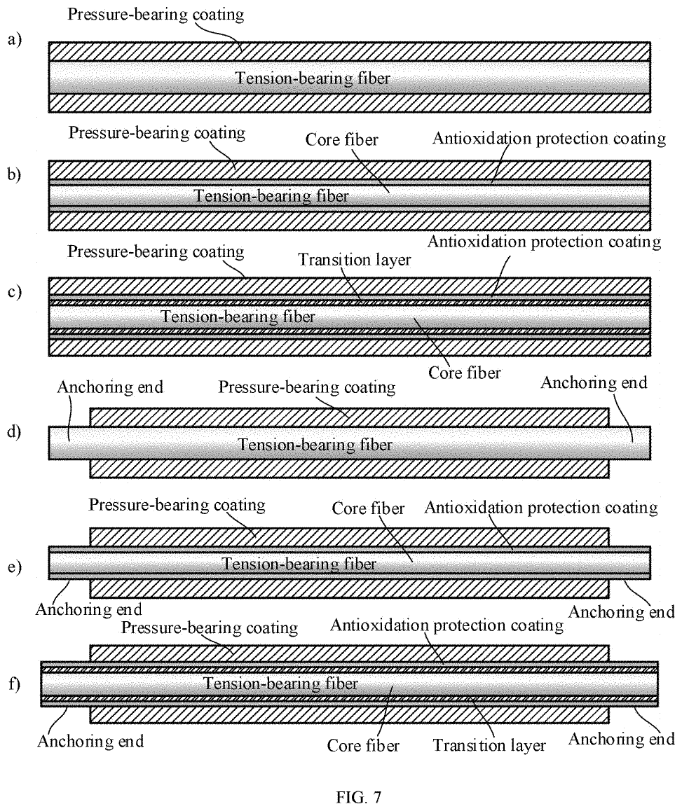

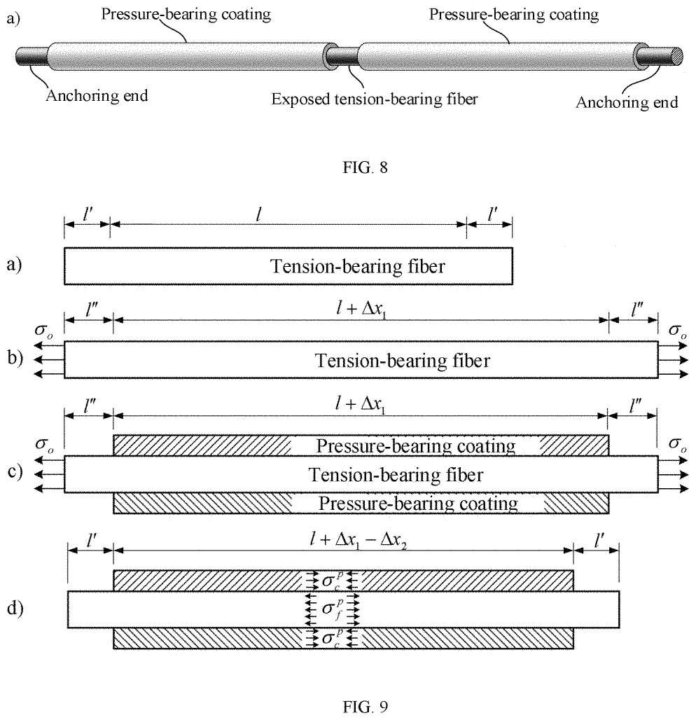

### DETAILED DESCRIPTION OF PREFERRED EMBODIMENTS

Sample Calculation for the Memory Fiber Reinforced Composite Material

Basic Parameters of the Material

The pressure-bearing coating of the memory fiber adopts C coating, the tension-bearing fiber adopts SiC fiber and the preparation method for the pressure-bearing coating adopts CVD method. When the volume fraction (v %) of the tension-bearing fiber is 14.2 v %, the volume fraction of the pressure-bearing coating is 85.8 v % and the prestressing force stored in the tension-bearing fiber reaches the maximum. The dosage of the memory fiber in the composite material is 50 v %, basic parameters of the pressure-bearing coating, the tension-bearing fiber and the matrix are shown in table 1. As materials of the tension-bearing fiber and the matrix are the same and the swelling coefficients are the same, after the pressure-bearing coating is oxidized, there is no thermal stress between the tension-bearing fiber and the matrix. The anchoring manner of the memory fiber in the matrix adopts the anchoring type with an exposed end. Namely by subjecting C coating in the end of the SiC tension-bearing fiber in the memory fiber to erosion treatment or by avoiding C coating in the end of the SiC tension-bearing fiber, the SiC tension-bearing fiber with an exposed end is directly bonding and anchoring within the matrix, the length l′ of the anchoring end is ≥50d (d is the diameter of the fiber).

TABLE 1
basic parameters for the pressure-bearing coating,
the tension-bearing fiber and the matrix

| | material type | | |
|---|---|---|---|
| | C material | SiC | |
| | pressure- | tension- | |
| | bearing | bearing | SiC |
| material parameter | coating | fiber | matrix |
| elasticity modulus/Gpa | 11 | 400 | 400 |
| volume fraction | 85.8%*50% | 14.2%*50% | 50% |
| initial tension stress σ₀ | — | 2000 MPa | — |

The maximum axial stress of the matrix:

assuming that the memory fiber is monodirectionally and uniformly distributed in the matrix, the cross-section of the pressure-bearing coating is lost and the compressive stress exerted on the matrix by the retraction of the memory fiber shape restoration reaches the maximum value.

the stress stored in the tension-bearing fiber is:

$${σ}_{f}^{p} = \frac{11 \times 1 {0}^{3} \times 85.8 \% \times 2000}{11 \times 1 {0}^{3} \times 85.8 \% + 400 \times 1 {0}^{3} \times 14.2 \%} = 285 \qquad ( MPa )$$

the prestressing force exerted on the matrix by the retraction of the tension-bearing fiber is:

$${σ}_{m}^{p} = - \frac{400 \times 1 {0}^{3} \times 7.1 \% \times 285}{400 \times 1 {0}^{3} \times 7.1 \% + 400 \times 1 {0}^{3} \times 50 \%} = - 35.4 \qquad ( MPa )$$

It can be known from the above calculation results that the precompressive stress exerted on the matrix by the memory fiber reaches 35.4 MPa and if the volume fraction of the memory fiber and the initial tension force of the tension-bearing fiber continue to increase, then the compressive stress exerted on the matrix will continue to increase.

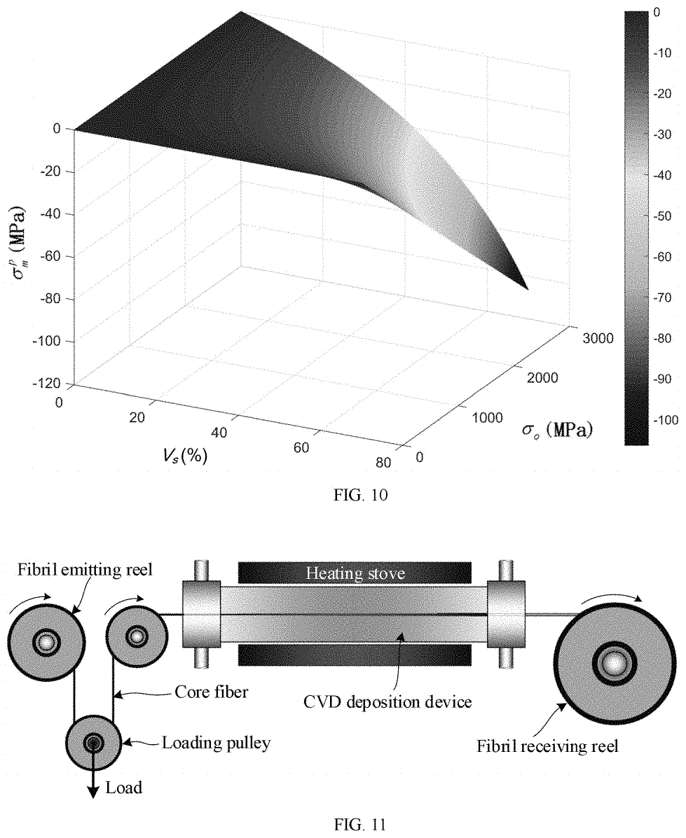

As shown in FIG. 10, when the volume fraction Vₛ of the memory fiber and the initial tension force σₒ of the tension-bearing fiber continue to increase, the precompressive stress of the matrix will continue to increase. Therefore, the size of the compressive stress can be controlled by the size and volume fraction of the initial tension stress of the memory fiber, which means the exertion of pressure press can contribute to close cracks of the matrix, decrease the stress concentration, increase the rigidity, improve the antioxidantive ability and improve the tenacity.

### Embodiment 1

The tension-bearing fiber of the memory fiber in the present embodiment adopts SiC fiber, the pressure-bearing coating of the tension-bearing fiber adopts the oxidative C coating and the matrix material is SiC ceramics material. The memory fiber adopts the anchoring type with an exposed end and without the oxidative coating, namely the end exposed with the SiC tension-bearing fiber is bonding and anchoring with the SiC matrix and the length of the anchoring end is no less than 50d.

The tension-bearing fiber adopts SiC fiber with a diameter about 11 μm. The continual preparation device of deposing the oxidative coating is shown in FIG. 11, wherein the SiC fiber enters the deposition furnace from the fibril emitting reel to deposit the coating and then furl the fibril receiving reel. During the deposition process, a constant tension force is exerted by adjusting the loading pulley to allow the initial tension stress σₒ of the SiC fiber to maintain 1800 MPa. The cleavage structure of the SiC core memory fiber is SiC core/C coating, namely the pyrolytic carbon pressure-bearing coating (oxidative pressure-bearing coating) is deposited on the surface of the SiC tension-bearing fiber. The method that the SiC pressure-bearing fiber deposits C coating is as follow:

The chemical vapor deposition (CVD) is adopted to deposit C coating, wherein the initial tension stress of the SiC tension-bearing fiber is 1800 MPa, the gas source adopts the mixing gas of propylene and tetrachloromethane with the respective gas flow being 500 ml/min and 400 ml/min, the deposition temperature is 1000° C., the pressure within the deposition furnace is 0.5-1.5 kPa, the fibril movement speed o the fiber in the furnace is 1 mm/min and the whole process is protected by argon. When the coating reaches the designed thickness, the deposition is finished, the tension force of the fiber is removed and the deposition furnace is cooled to room temperature, wherein the thickness of the pyrolytic carbon oxidative pressure-bearing coating is about 5 μm.

An oxidation-induced shape memory fiber with a diameter about 21 μm can be prepared by the above-mentioned method and the pressure-bearing coating of the memory fiber is the C coating with a thickness of 5 μm. The C coating with a length about 5 mm in the end of the SiC tension-bearing fiber of the memory fiber is removed by slight erosion to pre-reserve the anchoring end exposed with the SiC tension-bearing fiber, namely the end exposed with the SiC tension-bearing fiber is bonding and anchoring within the matrix. Then the oxidation-induced shape memory fiber is compiled into a prefab and the density of the prefab is 0.9 g/cm³. The chemical vapor infiltration (CVI) is adopted to prepare the memory fiber reinforced SiC ceramics matrix self-healing composite material and the preparation method is:

The prefab is put into a normal isothermal CVI deposition furnace to perform SiC deposition, wherein the deposition temperature is 1100° C., the raw gas adopts argon or nitrogen as the diluent gas with a gas flow of 900 ml/min, methyltrichlorosilane is chosen as the reaction gas and the flow of methyltrichlorosilane is 1.0 g/min, hydrogen is chosen as the vector and the flow of hydrogen is 500 ml/min, the reaction period is 200 hours, and the density of the finally prepared memory fiber reinforced SiC ceramics matrix self-healing composite material is 2.3 g/cm³.

### Embodiment 2

The tension-bearing fiber of the memory fiber in the present embodiment adopts SiC fiber, the pressure-bearing coating adopts the oxidative carbon-rich B—C coating and the matrix material is SiC ceramics material. The memory fiber adopts the anchoring type with an exposed end and without the oxidative coating, namely the end exposed with the SiC tension-bearing fiber is bonding and anchoring with the SiC matrix and the length of the anchoring end is no less than 50d.

The tension-bearing fiber adopts SiC fiber with a diameter about 11 μm. The continual preparation device of deposing the oxidative coating is shown in FIG. 11, wherein the SiC fiber enters the deposition furnace from the fibril emitting reel to deposit the coating and then furl the fibril receiving reel. During the deposition process, a constant tension force is exerted by adjusting the loading pulley to allow the initial tension stress σₒ of the SiC fiber to maintain 1800 MPa. The cleavage structure of the SiC core memory fiber is SiC core/pyrolytic C coating/carbon-rich B—C coating, namely the first coating of the SiC tension-bearing fiber is pyrolytic C coating (transition layer) and the second coating is the carbon-rich B—C coating (oxidative pressure-bearing coating). Each deposition step for the coating of the SiC tension-bearing fiber is as follow:

step 1: the first coating is deposited by the chemical vapor deposition (CVD), wherein a constant tension force is exerted by the loading pulley to allow the initial tension stress σₒ of the SiC tension-bearing fiber to be 1800 MPa, then the coating is continually deposited on the surface of the SiC tension-bearing fiber, the gas source for deposition adopts the mixing gas of propylene and tetrachloromethane with the respective gas flow being 400 ml/min and 400 ml/min, the deposition temperature is 1000° C., the internal pressure of the deposition furnace is 0.5-1.3 kPa, the fibril movement speed of the fiber in the furnace is 200 mm/min, the whole process is protected by argon, the deposited pyrolytic C coating with the thickness of 0.1 μm is obtained and the pyrolytic C coating is firstly oxidized by the entered oxidation mediums to quicken the restoration speed of the memory fiber.

step 2: the second coating is deposited on the surface of the first coating with the same method and the tension force is the same with that in step 1, wherein the reaction gas for deposition is CH₄, BCl₃ and hydrogen, the diluent gas is argon, the fibril movement speed of the fiber in the furnace is 3 mm/min and the deposition temperature is 1100° C. The gas flow of CH₄, BCl₃ and hydrogen is respectively 500 ml/min, 400 ml/min and 1200 ml/min, the gas flow of argon is 600 ml/min, the pressure is 9-10 KPa, when the coating reaches the designed thickness, the deposition is finished, the tension force of the fiber is removed and cooled to room temperature to obtain the carbon-rich B—C ceramics coating with a thickness about 4.2 μm, wherein the stoichiometric ratio of B element and C element in the carbon-rich B—C ceramics coating is about 1.2:1.

A SiC core oxidation-induced shape memory fiber with a diameter about 19.6 μm can be prepared by the above-mentioned method and the pressure-bearing coating of the memory fiber is the second coating, i.e. the carbon-rich B—C ceramics coating with a thickness of 4.2 μm. The surface pyrolytic C coating with a length about 5 mm in the end of the SiC core and carbon-rich B—C coating are removed by slight erosion and alkali to pre-reserve the anchoring end exposed with the SiC core, namely the end exposed with the SiC tension-bearing fiber is bonding and anchoring with the SiC matrix. Then the memory fiber is compiled into a prefab and the density of the prefab is 1 g/cm³. The chemical vapor infiltration (CVI) is adopted to prepare the memory fiber reinforced SiC ceramics matrix self-healing composite material and the preparation method is:

The prefab is put into a normal isothermal CVI deposition furnace to perform SiC matrix deposition, wherein the deposition temperature is 1100° C., the raw gas adopts argon or nitrogen as the diluent gas with a gas flow of 900 ml/min, methyltrichlorosilane is chosen as the reaction gas and the flow thereof is 1.0 g/min, hydrogen is chosen as the vector and the flow of hydrogen is 500 ml/min, the reaction period is 220 hours, and the density of the finally prepared memory fiber reinforced SiC ceramics matrix self-healing composite material is 2.2 g/cm³.

### Embodiment 3

The present embodiment adopts the C fiber coated with the SiC protection coating as the tension-bearing fiber and the pressure-bearing coating adopts the oxidative coating, the matrix material is SiC ceramics material. The length for the anchoring end of the memory fiber is no less than 50d and the anchoring end adopts the anchoring type with an exposed end and without the oxidative coating to ensure that the end of C core fiber coated with the SiC protection coating is bonding and anchoring with the SiC matrix.

C fiber adopts the PAN matrix T1000 carbon fiber produced by TORAY INDUSTRIES, INC. and the diameter of C fiber is about 5 μm. Before the deposition of the coating, the colloid on the surface of C fiber is removed by refluxing acetone, C fiber is immersed in the acetone solution of 70° C. in the reflux device for 48 hours to remove the colloid on the surface of C fiber, and then the carbon fiber is taken out and dried. The continual preparation device of deposing the oxidative coating is shown in FIG. 11, wherein the SiC fiber enters the deposition furnace from the fibril emitting reel to deposit the coating and then furl the fibril receiving reel. During the deposition process, a constant tension force is exerted by adjusting the loading pulley to allow the initial tension stress σₒ of the SiC fiber to maintain 2000 MPa. The cleavage structure of the SiC core memory fiber is C fiber/pyrolytic C coating/SiC coating/C coating, wherein the first coating of the C fiber is composed of the pyrolytic C coating (transition layer) and the second coating is SiC coating (protection coating) and the third coating is C coating (oxidative pressure-bearing coating). Deposition steps for each coating of C fiber are as follow:

step 1: the first coating is deposited by the chemical vapor deposition (CVD), wherein the initial tension stress σₒ of the SiC tension-bearing fiber to be 2000 MPa, the gas source adopts the mixing gas of propylene and tetrachloromethane with the respective gas flow being 400 ml/min and 400 ml/min, the deposition temperature is 1000° C., the internal pressure of the deposition furnace is 0.5-1.3 kPa, the fibril movement speed of the fiber in the furnace is 200 mm/min, the whole process is protected by argon, the deposited pyrolytic C coating with the thickness of 0.1 μm is obtained to improve the interface bonding of the C fiber and the SiC protection coating.

step 2: the second coating is deposited on the surface of the first coating with the CVD method and the tension force of the fiber is the same with that in step 1, wherein the reaction gas adopts methyltrichlorosilane and hydrogen is vector with a vector gas flow of 400 ml/min, the diluent gas is argon with a gas flow of 500 ml/min, the pressure is 18 KPa, the fibril movement speed of the fiber in the furnace is 120 mm/min and the deposition temperature is 1000° C. and the tension-bearing fiber is obtained by deposition, which has SiC coating with a thickness of about 0.4 nm as the protection coating of C fiber, namely it has the antioxidative protection coating with the C fiber as the core.

step 3: the third coating is continued to deposit on the surface of the second coating with the CVD method and the tension force of the fiber is the same with that in step 1. The gas source adopts the mixing gas of propylene and tetrachloromethane with the respective gas flow being 500 ml/min and 400 ml/min, the deposition temperature is 1000° C., the fibril movement speed of the fiber in the furnace is 5 mm/min, the whole process is protected by argon. When the coating reaches the designed thickness, the deposition is finished, the tension force of the fiber is removed and the deposition furnace is cooled to room temperature to obtain the pyrolytic carbon oxidative pressure-bearing coating with a thickness about 3.8 μm.

An oxidation-induced shape memory fiber with a diameter about 13.6 μm is prepared through the above-mentioned three steps and the pressure-bearing coating of the memory fiber is third coating, namely the pyrolytic carbon with the thickness of 3.8 μm. The end of C fiber coated with the SiC protection coating is subjected to slight erosion to remove C coating with a length about 5 mm on the surface of the SiC protection coating and to expose the SiC protection coating and bond and anchor within the matrix. Then the oxidation-induced shape memory fiber is compiled into a prefab and the density of the prefab is 0.4˜0.6 g/cm³, the memory fiber reinforced SiC ceramics matrix self-healing composite material is prepared by the chemical vapor infiltration (CVI) and the embedding method, steps thereof are as follow:

step 4: the pyrolytic carbon deposited on the prefab is densified with the isothermal CVI process, wherein the deposition uses the soaking vacuum induced gas phase deposition furnace, the deposition temperature is 1100° C., the precursor of the carbon source adopts the diluent gas of propylene (CH₄) and hydrogen (H₂) and the volume ratio of CH₄ to H₂ is 1:2, the deposition goes on for about 200 hours to prepare the porous memory fiber/carbon composite material with a density about 1.4 g/cm³.

step 5: the above-mentioned densified composite material is put into high temperature reaction furnace to perform the silicon permeation by melting, wherein the dosage of silicon powder used for embedding is 1.2 times of the theoretical demanding value, the purity of the silicon powder is 99% and the granularity is 0.01-0.1 mm. The reaction furnace is vacuumized to −0.1 MPa, the vacuum is kept for 30 minutes, argon is aerated to the normal pressure, the temperature in the furnace is increased to 1500° C. 1600° C. at a speed of 5° C./min and the heat is preserved for 1-2 hours, then it is cooled to room temperature at the speed of 10° C./min to obtain the memory fiber reinforced SiC ceramics matrix self-healing composite material with a density about 2.0 g/cm³.

### Embodiment 4

The present embodiment adopts the C fiber coated with the SiC protection coating as the tension-bearing fiber, the pressure-bearing coating adopts the oxidative carbon-rich B—C coating and the matrix material is SiC ceramics material. The length of the anchoring end in the memory fiber is no less than 50d and the anchoring end adopts the anchoring type with an exposed end and without the oxidative coating to ensure that the end of the tension-bearing fiber bonds and anchors with the SiC matrix.

Before the deposition of the coating, the colloid on the surface of C fiber is removed by refluxing acetone, C fiber is immersed in the acetone solution of 70° C. in the reflux device for 48 hours to remove the colloid on the surface of C fiber, and then the carbon fiber is taken out and dried. The continual preparation device of deposing the oxidative coating is shown in FIG. 11, wherein the SiC fiber enters the deposition furnace from the fibril emitting reel to deposit the coating and then furl the fibril receiving reel. During the deposition process, a constant tension force is exerted by adjusting the loading pulley to allow the initial tension stress σₒ of the SiC fiber to maintain 2000 MPa. The cleavage structure of the memory fiber is C fiber/pyrolytic C coating/SiC coating/carbon-rich B—C coating, namely the first coating of the C fiber is composed of the pyrolytic C coating (transition layer) and the second coating is SiC coating (protection coating) and the third coating is carbon-rich B—C coating (oxidative pressure-bearing coating). Deposition steps of each coating of C fiber are as follow:

step1: the first coating is deposited by the chemical vapor deposition (CVD), wherein the initial tension stress σₒ of the C fiber is 2000 MPa, the gas source adopts the mixing gas of propylene and tetrachloromethane with the respective gas flow being 400 ml/min and 400 ml/min, the deposition temperature is 1000° C., the internal pressure of the deposition furnace is 0.5-1.3 kPa, the fibril movement speed of the fiber in the furnace is 200 mm/min, the whole process is protected by argon and a pyrolytic C coating with the thickness of 0.1 μm is obtained to improve the interface bonding of the C fiber and the SiC protection coating.

step 2: the second coating is deposited on the surface of the first coating with the CVD method and the tension force of the fiber is the same with that in step 1. methyltrichlorosilane is chosen as the reaction gas, hydrogen as the vector with the vector gas flow of 400 ml/min, argon as the diluent gas with the gas flow of 500 ml/min, the pressure is 18 KPa, the fibril movement speed of the fiber in the furnace is 120 mm/min, the deposition temperature is 1000° C. and the tension-bearing fiber is obtained by deposition, which has SiC coating with a thickness of about 0.4 μm as the protection coating of C fiber, namely it has the antioxidative protection coating with the C fiber as the core.

step 3: the third coating is continued to deposit on the surface of the second coating with the CVD method and the tension force of the fiber is the same with that in step 1. The gas source for deposition adopts CH₄, BCl₃ and hydrogen, the fibril movement speed of the fiber in the furnace is 4 mm/min, the deposition temperature is 1100° C. The gas flow of CH₄, BCl₃ and hydrogen is respectively 500 ml/min, 500 ml/min and 1000 ml/min, the gas flow of argon is 600 ml/min, the pressure is 9-10 KPa, when the coating reaches the designed thickness, the deposition is finished, the tension force of the fiber is removed and cooled to room temperature to obtain the carbon-rich B—C ceramics coating with a thickness about 3.3 μm, wherein the stoichiometric ratio of B element and C element in the carbon-rich B—C ceramics coating is about 1.6:1.

An oxidation-induced shape memory fiber with a diameter about 12.6 μm can be prepared by the above-mentioned three steps and the pressure-bearing coating of the memory fiber is the third coating, i.e. the carbon-rich B—C ceramics coating with a thickness of 3.3 μm. The end of C fiber coated with the SiC protection coating is washed with slight erosion and strong alkali to remove carbon-rich B—C coating with a length about 5 mm on the surface of the SiC protection coating to expose SiC protection coating and bond and anchor within the matrix. Then the oxidation-induced shape memory fiber is compiled into a prefab and the density of the prefab is 1.3 g/cm³. The chemical vapor infiltration (CVI) is adopted to prepare the memory fiber reinforced SiC ceramics matrix self-healing composite material and the preparation method is:

The prefab is put into a normal isothermal CVI deposition furnace to perform SiC deposition, wherein the deposition temperature is 1100° C., the raw gas adopts argon as the diluent gas with a gas flow of 900 ml/min, methyltrichlorosilane is chosen as the reaction gas and the flow thereof is 1.0 g/min, hydrogen is chosen as the vector and the flow of hydrogen is 500 ml/min, the reaction period is 200 hours, and the density of the finally prepared memory fiber reinforced SiC ceramics matrix self-healing composite material is 2.15 g/cm³.

### Simulation Verification for Values of Closing the Crack:

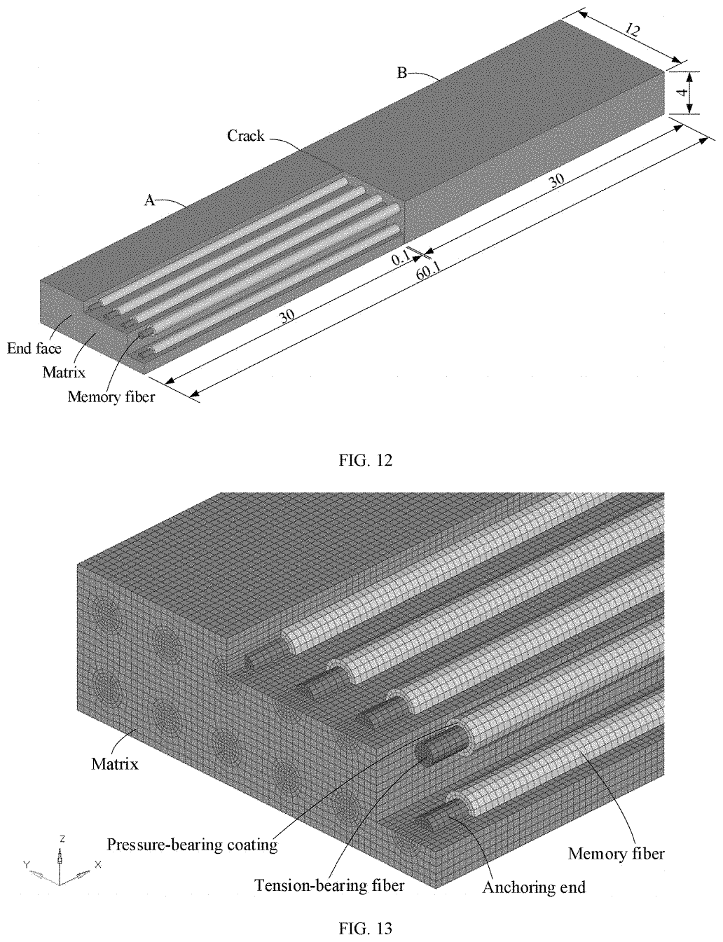

1, A finite element model is built with parameters in embodiment 1, and the finite element model is shown in FIG. 12, wherein the memory fiber enforce SiC ceramics matrix self-healing composite material is composed of A member, B member and the memory fiber, the overall size of the model is 60.1 mm×12 mm×4 mm (length×width×thickness) and the memory fiber is arranged and distributed along the length direction of the model. There is a perforative crack with a width of 0.1 mm preserved between A member (30 mm×12 mm×4 mm) and B member (30 mm×12 mm×4 mm) of the model and the SiC matrix, which acts as the channel of the oxidation mediums. Both the two A and B members of the model are connected with 12 member fibers whose length is 58.9 mm and diameter is 1 mm and the tension-bearing fiber of each fiber adopts the SiC fiber whose diameter is 0.6 mm and the strength is 3000 MPa, wherein the anchoring ends exposed on both ends all have the length of 1.2 mm. The initial tension stress of the SiC tension-bearing fiber by pre-exerting stress is 2000 MPa, the pressure-bearing coating is C coating and the thickness is 0.2 mm. The model grind division is shown in FIG. 13, the size of grids in the matrix is 0.2 mm and the pressure-bearing coating, the tension-bearing fiber and the matrix units are treated with conode. All unit nodes on the end face of A member in the model are restrained in the x axis direction, wherein the node in the lower right corner of outside end face is restrained in yz plane, other nodes in the outside end face are free on the yz plane and the entire B member is free. The environment temperature is set as 800° C., the air pressure is 1 barometric pressure and it is a pure oxygen environment. The oxidation speed of the SiC material is set as 0.01 mm/min and the oxidation speed of the C coating material is set as 5 mm/min. The hardware used in the present simulation is a computer; the Hypermesh software is used to build the model and the ANSYS finite element analysis software is used to perform equivalent simulation analysis; of course, all software including finite element software such as ABAQUS that can realize the present simulation function can be used in the present disclosure.

The models in the control group is basically the same with the memory fiber enforce SiC ceramics matrix self-healing composite material model and the distinction lies in that there is not mechanic and interactive force between the SiC fiber in the control group and the C coating, namely after the C coating of the reinforced fiber is oxidized and corroded, retraction does not occur in the SiC core fiber.

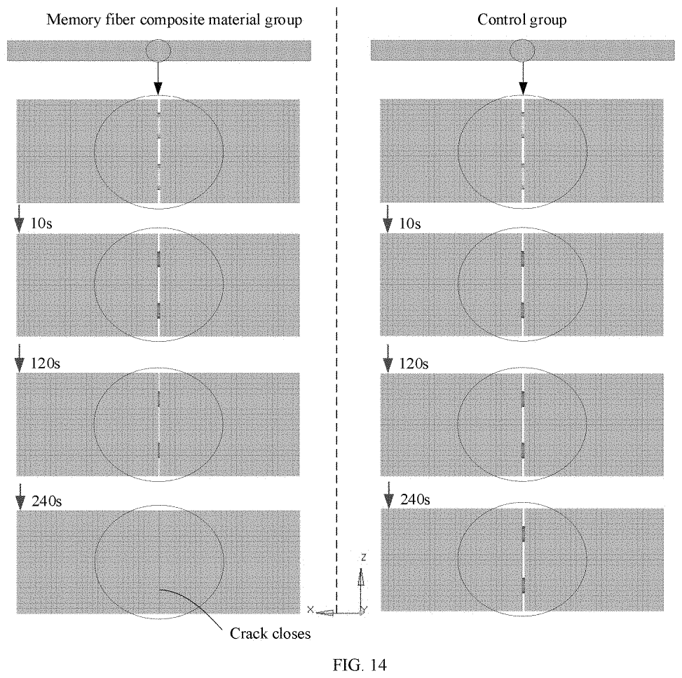

2, The simulation oxidation contrast phenomenon and process are shown in FIG. 14, wherein the left figure shows the memory fiber forced composite material, a cross-section loss occurs in the C coating in the crack after 10 s of oxidation, an extremely small closing occurs in the crack, the width of the crack becomes 0.06 mm after 120 s and the crack is completely closed after 240 s; the right figure shows the control group, wherein a cross-section loss occurs in the C coating in the crack and the width of the crack is observed with no changes after 10 s of oxidation, the width of the crack is still observed with no changes after 120 s and there is no changes observed in the width of the crack after 240 s.

3, conclusions: it can be discovered from the simulation results that as self-healing function occurs in the memory fiber enforce SiC ceramics matrix self-healing composite material, during the oxidation experiment process and when the oxidation mediums enters the internal of the material to oxidize the C pressure-bearing coating to allow the memory fiber to be excited and retracted, exert pressure on the SiC matrix, close cracks, cut the oxidation channel, which can improve the antioxidantive ability of the composite material; however as the reinforced fiber in the test piece of the control group does not have memory function, after C coating simulation is oxidized and lost, the SiC fiber will not retract and exert pressure on the matrix to close the matrix, the C pressure-bearing coating will continue to be oxidized by the oxidation mediums from the outside and the fiber inside of the material will continue to be oxidized, which can result in the structural invalidation of the composite material very easily; therefore, it has obvious advantages to adopt the memory fiber in self-healing and antioxidantive ability aspect.

Of course, the above explanation is merely a preferred embodiment of the present disclosure, and the present disclosure is not limited to the above embodiment. It should be noted that all equivalent replacements made by those skilled in the art under the teaching of the present specification are within the essential scope of the present specification, and it should be protected by the present disclosure.

What is claimed is:

1. An oxidation-induced shape memory fiber, characterized in that
the oxidation-induced shape memory fiber comprises a tension-bearing core material and an oxidizable pressure-bearing coating, the oxidizable pressure-bearing coating is coated outside of the tension-bearing core material and the end of the tension-bearing core material is not coated with the oxidizable pressure-bearing coating; the end of the tension-bearing core material which is not coated with the oxidizable pressure-bearing coating is defined as an anchoring end; under the equivalent oxidation conditions and experimental situations, the oxidation speed of the oxidizable pressure-bearing coating is bigger than the oxidation speed of the tension-bearing core material; the oxidizable pressure-bearing coating is in a compressive stress state along the length direction of the tension-bearing core material; and the tension-bearing core material and the oxidizable pressure-bearing coating are in a tension-compression balance state along the length direction of the tension-bearing core material.

2. The oxidation-induced shape memory fiber according to claim 1, characterized in that the tension-bearing core material is composed of an antioxidative material or a non-antioxidative material coated with an antioxidative material coating.

3. The oxidation-induced shape memory fiber according to claim 1, characterized in that an extremely oxidizable coating is arranged between the tension-bearing core material and the oxidizable pressure-bearing coating; the cross-section of the oxidation-induced shape memory fiber is the tension-bearing core material, the extremely oxidizable coating and the oxidizable pressure-bearing coating from inside to the outside in succession, under the equivalent oxidation conditions and experimental situations, the antioxidative ability of the three materials, namely tension-bearing core material, the oxidizable pressure-bearing coating and the extremely oxidizable coating, decreases successively while the cross-section oxidation loss rate increases successively; the oxidizable pressure-bearing coating is in a compressive stress state along the length direction of the tension-bearing core material; and the tension-bearing core material and the oxidizable pressure-bearing coating are in a tension-compression balance state along the length direction of the tension-bearing core material.

4. The oxidation-induced shape memory fiber according to claim 1, characterized in that the outer surface of the end or other positions of the memory fiber is coated with a second antioxidative coating; the sections where the surface of the end or other positions of the memory fiber is coated with the second antioxidative coating are defined as reinforced anchoring ends.

5. The oxidation-induced shape memory fiber according to claim 1, characterized in that the oxidation environment includes at least one of gas oxidation and liquid oxidation;
the core material is chosen from at least one of C, SiC, B₄C and metal fiber;
the antioxidative coating is chosen from at least one of SiC, B₄C, ZrC, TiC, HfC, TaC, NbC, Si₃N₄, BN, AN, TaN, CrSi₂, MoSi₂, TaSi₂, WSi₂, HfSi₂, Nb₅Si₃, V₅Si₃, CrB₂, TiB₂, ZrB₂ or the multiphase composite coating Hf—Ta—C and Hf—Si—C or is multilayer coated;
the oxidizable pressure-bearing coating is chosen from a C coating and a carbon-rich coating.

6. The oxidation-induced shape memory fiber according to claim 1, characterized in that the anchoring end plays a role of anchoring within a matrix; the anchor type of the anchoring end is chosen from the anchoring type with an exposed end; the exposed length of the anchoring type with an exposed end is l′; the l′ meets the formula:
$${l}^{′} \geq \frac{d {σ}_{f 1}}{4 \overline{τ}} .$$

7. A preparation method for the oxidation-induced shape memory fiber according to claim 1, characterized in that
reserving an anchoring end, exerting tension force on the core material or the core material with an antioxidative coating; then preparing a layer of oxidizable pressure-bearing coating on the surface thereof; removing the tension force to obtain a sample; or
reserving an anchoring end, exerting tension force on the core material or the core material with an antioxidative coating; then preparing a layer of oxidizable pressure-bearing coating on the surface thereof; removing the tension force, followed by coating a second antioxidative layer on a preset part of the oxidizable pressure-bearing coating; or
reserving an anchoring end, exerting tension force on the core material or the core material with an antioxidative coating; then preparing a layer of extremely oxidizable coating on the surface thereof, followed by coating an oxidizable pressure-bearing coating outside thereof; removing the tension force to obtain a sample;
the exerted tension force is 30% to 90% of the bearing force for the tension-bearing fiber or the tension-bearing fiber with the antioxidative coating.

8. The preparation method for the oxidation-induced shape memory fiber according to claim 7, characterized in that in the whole oxidation-induced shape memory fiber, in order to allow the prestressing force exerted on the outside by the memory fiber to reach the maximum, the optimal acquisition method is:
under the condition that the cross-sectional area of the oxidation-induced shape memory fiber is constant,
the magnitude of the prestressing force storage for the memory fiber is closely related to the volume fraction V_{f} of the tension-bearing fiber and the axial force F of the tension-bearing fiber is
$$F = {σ}_{f}^{p} {A}_{f} = \frac{{E}_{c} {V}_{c} {σ}_{o} {A}_{f}}{{E}_{c} {V}_{c} + {E}_{f} {V}_{f}} = \frac{{E}_{c} {V}_{c} {σ}_{o} {V}_{f} A}{{E}_{c} {V}_{c} + {E}_{f} {V}_{f}} = \frac{( 1 - {V}_{f} ) {V}_{f}}{{E}_{c} ( 1 - {V}_{f} ) + {E}_{f} {V}_{f}} {E}_{c} {σ}_{o} A \qquad ( 14 )$$
when F reaches the maximum, prestressing force to the outside from memory fiber will reach the maximum;
to calculate the extremum of the axial force for the tension-bearing fiber, firstly differentiating F:
$${F}^{′} = \frac{( 1 - 2 {V}_{f} ) [ {E}_{c} ( 1 - {V}_{f} ) + {E}_{f} {V}_{f} ] - ( {V}_{f} - {V}_{f}^{2} ) ( {E}_{f} - {E}_{c} )}{{[ {E}_{c} ( 1 - {V}_{f} ) + {E}_{f} {V}_{f} ]}^{2}} {E}_{c} {σ}_{o} A \qquad ( 15 )$$
that is
$${F}^{′} = \frac{( {E}_{c} - {E}_{f} ) {V}_{f}^{2} - 2 {E}_{c} {V}_{f} + {E}_{c}}{{[ {E}_{c} ( 1 - {V}_{f} ) + {E}_{f} {V}_{f} ]}^{2}} {E}_{c} {σ}_{o} A \qquad ( 16 )$$
taking F′=0:
(E_{c}−E_{f})V_{f}²−2E_{c}V_{f}+E_{c}=0 (17)
when E_{c}=E_{f}, then V_{f}=½, at this time F can take extremum, namely the Fmax;
$${V}_{f}^{2} - \frac{2 {E}_{c}}{{E}_{c} - {E}_{f}} {V}_{f} + \frac{{E}_{c}}{{E}_{c} - {E}_{f}} = 0 ,$$
when E_{c}≠E_{f}, specific to the equation taking
$$a = \frac{{E}_{c}}{{E}_{c} - {E}_{f}} ,$$
since E_{c}>0, E_{f}>0 then a<0 or a>1, so Δ=4a²−4a>0, the original equations have two different real roots:
$${V}_{f} = a \pm \sqrt{{a}^{2} - a} = \frac{{E}_{c} \pm \sqrt{{E}_{c} {E}_{f}}}{{E}_{c} - {E}_{f}} = \frac{1 \pm \sqrt{{E}_{f} / {E}_{c}}}{1 - {E}_{f} / {E}_{c}} \qquad ( 18 )$$
further since 0<V_{f}<1, when E_{c}<E_{f}, then
$${V}_{f} = \frac{1 + \sqrt{{E}_{f} / {E}_{c}}}{1 - {E}_{f} / {E}_{c}} < 0 ;$$
when E_{c}>E_{f}, then
$${V}_{f} = \frac{1 + \sqrt{{E}_{f} / {E}_{c}}}{1 - {E}_{f} / {E}_{c}} > 1 ,$$
and then the real root
$${V}_{f} = \frac{1 + \sqrt{{E}_{f} / {E}_{c}}}{1 - {E}_{f} / {E}_{c}}$$
does not meet the condition of 0<V_{f}<1 and should be abandoned; and when
$${V}_{f} = a - \sqrt{{a}^{2} - a} = \frac{{E}_{c} - \sqrt{{E}_{c} {E}_{f}}}{{E}_{c} - {E}_{f}} \qquad ( 19 )$$
V_{f} meets the condition of formula 19 and can allow F to take the maximum value, namely Fmax.

9. An application of the oxidation-induced shape memory fiber according to claim 1, characterized in that the oxidation-induced shape memory fiber is applied to reinforce the matrix; the matrix includes at least one of a ceramic matrix, a metal matrix and a concrete matrix and when the oxidation-induced shape memory fiber is applied in the ceramic matrix or the metal matrix, its volume consumption is 20-80 v %.

10. The application of the oxidation-induced shape memory fiber according to claim 9, characterized in that
when the material of the matrix is SiC and the core material of the oxidation-induced shape memory fiber is SiC fiber, the oxidizable pressure-bearing coating is C coating;
when the material of the matrix is SiC and the core material of the oxidation-induced shape memory fiber is C fiber with SiC coating, the oxidizable pressure-bearing coating is C coating;
when the oxidation-induced shape memory fiber is applied in the ultra-high temperature ceramic phase of Zr—Ti—C—B quaternary boron carbide and the core material of the oxidation-induced shape memory fiber is C fiber with SiC coating, the oxidizable pressure-bearing coating is a C coating or carbon-rich Bₓ—C or carbon-rich Si_{y}—C, wherein x≤2, y≤0.5.

11. The application of the oxidation-induced shape memory fiber according to claim 9, characterized in that the oxidation-induced shape memory fiber is applied in the reinforced matrix to obtain a composite material with self-healing function; in addition to configuring the memory fiber in the self-healing composite material, it further needs to anchor the memory fiber in the matrix and the antioxidantive ability of the matrix is higher than that of pressure-bearing coating of the memory fiber; the pressure-bearing coating comprises a carbon-rich pressure-bearing coating.

12. The application of the oxidation-induced shape memory fiber according to claim 9, characterized in that the antioxidantive ability of each constitute of the self-healing composite material reinforced by the oxidation-induced shape memory fiber meet the following conditions: the tension-bearing core material and the matrix>the oxidizable pressure-bearing coating>the extremely oxidizable coating.

13. The application of the oxidation-induced shape memory fiber according to claim 11, characterized in that the atomic ratio of C element in the carbon-rich pressure-bearing coating is bigger than the elemental stoichiometric ratio of the normal compounds and the stoichiometric ratio of M, K and C elements in carbon-rich Mₓ-K_{y}C pressure-bearing coating meets x+y [symbol] 2, wherein M represents at least one of IVA group metal elements or absence thereof, K represents at least one elements of B, Si, N or absence thereof.
